(19) United States
(12) Patent Application Publication
(10) Pub. No.: US 2025/0290249 A1
(43) Pub. Date: Sep. 18, 2025

(54) DIRECT TO FILM TRANSFER PROCESS FOR INKJET INKS ON SUBSTRATES USING PIGMENTED POLYMER POWDERS

(71) Applicant: Prism Inks, Inc., Sunnyvale, CA (US)

(72) Inventors: Amir A. AJANEE, Saratoga, CA (US); Graham A. DRACUP, Sunnyvale, CA (US); Carlos J. HERNANDEZ, San Jose, CA (US); Omar K. AJANEE, Saratoga, CA (US); Travis T. CALHOUN, San Jose, CA (US)

(73) Assignee: Prism Inks, Inc., Sunnyvale, CA (US)

(21) Appl. No.: 19/079,701

(22) Filed: Mar. 14, 2025

Related U.S. Application Data
(60) Provisional application No. 63/565,844, filed on Mar. 15, 2024.

(51) Int. Cl. D06P 5/28; D06P 1/52; D06P 1/673; D06P 3/52; D06P 3/60; D06P 5/30

(52) U.S. Cl. CPC D06P 5/006; D06P 3/52; D06P 3/60; D06P 5/30; D06P 1/5285; D06P 1/673

(57) ABSTRACT

Provided are methods for direct to film printing inkjet ink, the methods comprising: inkjet printing a design on a transfer film using inkjet ink; applying a pigmented polymer powder to the printed design on the transfer film; melting the pigmented polymer powder to form a pigmented polymer film overlying the printed design to form a pigmented printed design; and transferring the pigmented printed design from the transfer film to a substrate. The inkjet ink comprises dye sublimation pigment, pigment dispersion, and/or dye.

### CROSS-REFERENCE TO RELATED APPLICATIONS

This application claims priority to and the benefit of U.S. Provisional Application No. 63/565,844, filed Mar. 15, 2024, the contents of which are incorporated herein in its entirety.

### FIELD

This disclosure relates generally to direct to film printing processes for inkjet inks, and more specifically, to direct to film printing processes for inkjet inks using pigmented polymer powders.

### BACKGROUND

Various printing methods exist to print on cotton (or natural fiber) textiles or, alternatively, polyester (or synthetic fiber) textiles. For example, images can be printed on natural fiber fabrics (including cotton) using either rotary screen, flat bed, or engraved roll printing systems. Natural fiber textiles can also be printed on digitally using an inkjet printer. Another natural fiber textile printing method includes a hybrid of the rotary screen and inkjet processes.

Polyester (or synthetic fiber) fabrics can also be printed on using either rotary screen, flat bed, or engraved roll printing systems. Inkjet printing allows for printing directly to polyester (or synthetic fiber) fabrics or indirectly through two different transfer processes, using a polymer coated paper (transfer paper) or a polymer coated film.

Methods and processes for printing on cotton (or natural fiber) textiles require specific dyes or pigments to adhere to the natural textile, which is different than the specific dyes or pigments required for methods and processes for printing on synthetic fiber textiles. Both natural and synthetic textiles (and/or combinations thereof) can be printed on directly or indirectly. The indirect methods include using a polymer coated paper or film.

Currently, there are not many options for a single printing method or process to print on both cotton (and other natural fiber) textiles and polyester (and other synthetic) textiles (and/or combinations thereof). More specifically, there are no single printing methods or processes for printing light colors (e.g., white) onto both dark-colored natural fiber textiles and dark-colored synthetic fiber textiles (and/or combinations thereof). This is in part due to the lack of a single type of dye or pigment that can effectively adhere to both natural and synthetic textiles. To print digitally on a dark garment requires the use of a white ink. Inkjet printing white ink on dark colored garments has certain drawbacks such as clogging printheads and shifts in white color density due to the settling of the denser pigment in a low viscous medium.

Furthermore, there are few options for printing methods and processes that can print on both soft textiles and hard polymer-coated (e.g., polyester polymer-coated) or non-coated surfaces, such as an organic or inorganic material (e.g., ceramics, metal, wood, plastic, etc.). Therefore, there is a need for a single printing method and process to print onto each of natural textiles, synthetic textiles, combinations of natural and synthetic textiles, and hard polymer-coated and uncoated surfaces, and more specifically, to print both light colors (e.g., white) or dark colors onto either dark-colored or light-colored substrates (e.g., natural fiber textiles, synthetic fiber textiles, combinations of natural and synthetic textiles, and hard polymer-coated and uncoated surfaces).

### SUMMARY

Provided herein are methods and processes for printing inkjet inks (e.g., inks including dye sublimation pigments, pigment dispersions, and/or dyes) onto natural fiber textiles (e.g., cotton), synthetic fiber textiles (e.g., polyester), combinations of natural and synthetic fiber textiles, hard polymer-coated surfaces (e.g., polyester polymer-coated surfaces), and hard uncoated surfaces. Also provided are printed products comprising a pigmented printed image on a substrate (e.g., natural fiber textile, synthetic fiber textile, natural and synthetic fiber textile, hard polymer-coated surface, and hard uncoated surface). The printed product can include a light-colored image printed onto a dark-colored substrate. More specifically, by applying a pigmented polymer powder onto an inkjet ink-printed image, the methods and processes provided herein can print light-colored inkjet ink onto either dark-colored or light-colored substrates (e.g., natural fiber textiles, synthetic fiber textiles, natural and synthetic fiber textiles, hard polymer-coated surfaces, and hard uncoated surfaces). The inkjet ink can be colorless, and the pigmented polymer powder can be colored. The specific pigment used in the pigmented polymer powder dictates the color of the pigmented polymer powder, and thus, the color of the printed image on the substrate. For example, a white pigment (e.g., titanium dioxide) allows a white image to be printed onto a dark-colored substrate.

Other methods for printing inkjet inks on natural fiber textiles (e.g., cotton), synthetic fiber textiles (e.g., polyester), textiles including both natural fibers and synthetic fibers, hard polymer-coated surfaces, and hard uncoated surfaces can only print dark-colored dye sublimation ink onto a light-colored substrate. Accordingly, the methods and processes provided herein can achieve a broader range of applications and provide a superior alternative to the use of white ink that does not have the same deficiencies. For example, the methods and processes provided herein can result in improved color transfer and brightness of the printed image on the substrate.

As described above, many existing printing methods and processes can only be used for very narrow, specific applications. For example, a given method may only be able to print on natural fiber textiles. Another method may only be able to print on synthetic fiber textiles. A third method may only be able to print onto hard, polymer-coated or uncoated surfaces. Some methods/processes may be able to print dark-colored images on light substrates only, and not light-colored images on dark substrates. The methods and processes for printing inkjet ink provided herein can print both dark-colored images on light-colored substrates as well as light-colored images on dark-colored substrates by using a pigmented polymer, which provides a solution to the issues encountered with the use of white inkjet ink. Accordingly, the methods and processes provided herein are more efficient and less costly than other methods and processes. Using the methods and systems described herein, the use of a white ink, which can lead to down time due to clogging and require additional equipment and maintenance, is no longer required. The methods and processes provided herein can reduce the clogging, sedimentation and maintenance encountered with the use of a white ink.

The methods and processes provided herein include printing an image with inkjet ink onto a thermal/transfer film. A pigmented polymer powder is then applied to the printed image, and the particles of the pigmented polymer powder adhere to the printed image. The pigmented polymer powder includes a pigment (e.g., titanium dioxide). Heat is applied to the pigmented polymer powder to melt the pigmented polymer powder and form a film over the printed image, forming a pigmented printed image. The pigmented printed image may then be transferred from the transfer film to a substrate (e.g., natural fiber textile, synthetic fiber textile, natural and synthetic fiber textile, hard polymer-coated surface, or uncoated surface), forming a printed product. In some embodiments, the pigmented printed image may be pressed after the transfer to the substrate.

In some aspects, a method for direct to film printing inkjet ink is provided herein, the method comprising: inkjet printing a design on a transfer film using inkjet ink; applying a pigmented polymer powder to the printed design on the transfer film; melting the pigmented polymer powder to form a pigmented polymer film overlying the printed design to form a pigmented printed design; and transferring the pigmented printed design from the transfer film to a substrate.

In some aspects, a printed product prepared from the aforementioned method for direct to film printing inkjet ink is provided.

Optionally, the inkjet ink comprises a dye sublimation pigment, pigment dispersion, and/or dye. Optionally, inkjet printing the design on the transfer film using the inkjet ink comprises inkjet printing using an inkjet printer comprising piezo or thermal printheads. Optionally, melting the pigmented polymer powder comprises applying a heat source to the pigmented printed design at 250-350° F. for 30-120 seconds. Optionally, the heat source comprises conductive heater, a convective heater, and/or a radiative heater. Optionally, transferring the pigmented printed design from the transfer film to the substrate comprises applying a heat press to the transfer film comprising the pigmented printed design that is pressed face down on the substrate. Optionally, the heat press is applied at 300-400° F. for 1-10 seconds. Optionally, the method comprises removing the transfer film from the pigmented printed design to form a printed substrate. Optionally, the method comprises post pressing the printed substrate at 300-400° F. for 1-10 seconds. Optionally, applying the pigmented polymer powder to the printed design on the transfer film to form the pigmented printed design comprises applying 0.03-0.05 g powder/in² ink to the printed design. Optionally, the substrate comprises one or more of cotton, cellulose, polyamide, polyvinylchloride, polyacrylate, polyurethane, and/or polyvinylacetate. Optionally, the substrate is dark in color. Optionally, the pigmented polymer powder is light in color. Optionally, the pigmented polymer powder is white. Optionally, a polymer of the pigmented polymer powder comprises one or more of polyester or polyurethane. Optionally, a pigment of the pigmented polymer powder comprises one or more of titanium dioxide, zinc sulfide, zinc oxide, lithopones, lead carbonate, antimony (III) oxide, calcium carbonate, barium sulfate, or talc. Optionally, the transfer film is a cold peel film. Optionally, the transfer film is a hot peel film.

### BRIEF DESCRIPTION OF THE FIGURES

FIG. 1A shows a cross-sectional view of an image printed onto a transfer film using inkjet ink, according to some embodiments;

FIG. 1B shows a cross-section view of pigmented polymer powder applied to the printed image of FIG. 1A and heated, according to some embodiments;

FIG. 1C shows a cross-sectional view of a film layered on top of the printed image of FIG. 1A and formed from the pigmented polymer powder applied in FIG. 1B, according to some embodiments;

FIG. 1D shows a cross-sectional view of a transferring assembly, according to some embodiments;

FIG. 1E shows a cross-sectional view of a substrate with a printed image comprising a pigmented polymer film, according to some embodiments;

FIG. 2 shows a process for printing inkjet ink onto a substrate using pigmented polymer powders, according to some embodiments;

FIG. 3 shows a closed system process for applying pigmented polymer powders to a substrate having inkjet ink printed thereon and heating the substrate, according to some embodiments; and

FIG. 4 shows a graph depicting the results of the brightness in ink color when various amounts of white pigment are used in the polymer powder for printing direct to film, in accordance with some embodiments.

### DETAILED DESCRIPTION

Provided herein are methods and processes for printing inkjet ink (e.g., inks including dye sublimation pigment, pigment dispersion, and/or dye) onto natural fiber fabrics, synthetic fiber fabrics, fabrics including both natural and synthetic fibers, polymer-coated hard surfaces, and uncoated hard surfaces (collectively referred to herein as substrates) using pigmented polymer powders. The pigmented polymer powders can allow the methods and processes provided herein to print light-colored images onto dark-colored substrates (e.g., natural fiber textiles, synthetic fiber textiles, textiles including both natural and synthetic fibers, hard polymer-coated surfaces, and hard uncoated surfaces). For example, the methods and processes provided herein can employ a white pigmented polymer powder that enables printing on dark-colored substrates. The inkjet ink used with the pigmented polymer powder can be colorless (i.e., clear). The methods and processes provided herein can also print dark-colored images onto light-colored substrates. By applying a pigmented polymer powder onto a printed inkjet ink image on a transfer film to form a pigmented printed image, and then subsequently transferring the pigmented printed image onto a substrate, the methods and processes provided herein can achieve various goals depending on the desired printed product. For example, the methods and processes provided herein can print on each of natural fiber textiles, synthetic fiber textiles, natural and synthetic fiber textiles, hard polymer-coated surfaces, and hard uncoated surfaces.

As described above, printing digitally on a dark garment requires the use of a white ink. Inkjet printing white ink on dark colored garments has certain drawbacks such as clogging printheads and shifts in white color density due to the settling of the denser pigment in a low viscous medium. These drawbacks can be eliminated with the use of a pigmented polymer used as a hot melt adhesive. These pigmented polymer powders can be used in a direct to film process. The methods and processes provided herein can print both dark-colored images on light substrates, and light-colored images on dark substrates. Using inkjet inks including dye sublimating pigments, pigmented dispersions, and/or dyes in conjunction with a pigmented polymer as an adhesive allows printing on any type of natural and/or synthetic textile, hard or soft surface (coated or uncoated), and in any color, dark or light, without the drawbacks (e.g., clogging, sedimentation, and maintenance) of having to use white ink. By being able to produce different types of printed products, the methods and processes provided herein can be more efficient and less costly than other printing methods and processes, which typically require different equipment depending on the desired product. Moreover, the methods and processes provided herein can result in improved color transfer and brightness of the printed image on the substrate.

As described in greater detail below, an image is first printed onto a transfer film with inkjet ink, such as an ink including dye sublimation pigment, pigment dispersion, and/or dye. A pigmented polymer powder is applied to the freshly printed image, adhering to the printed ink. Heat may be applied to the pigmented polymer powder, melting the pigmented polymer powder to form a polymer film on top of the printed ink. The printed image (with polymer film) can then be transferred to the desired substrate (e.g., natural fiber textile, synthetic fiber textile, natural and synthetic fiber textile, hard polymer-coated surface, and hard uncoated surface) to form a printed product. In some embodiments, the printed image may be light in color, and the substrate may be dark in color.

The polymer powder used in the methods and processes described herein may be used with dye sublimation inks (e.g., inks including dye sublimation pigments and/or pigment dispersions) because the sublimating dye pigments can adequately adhere to the polymer powder when sublimating. Therefore, use of the polymer powder can allow for adequate image transfer from the film to the substrate. Using the polymer powder may also allow for superior dry crock and/or wet crock results, as well as increased color density and/or improved wash fastness with repeated laundering. Polymer powders that may commonly be used in direct to film processes may include, for example, polyurethanes, polyacrylics, polyvinylchlorides, polyvinylacetates, polyethylene, polypropylene, polycarbonate, polystyrene, ABS, polyamides, PEEK, poly(ethylene terephthalate), poly(ether sulphone), and/or co/ter-polymers thereof. It has been discovered that these polymers, while not typically used for direct to film printing processes, can be used for direct to film printing processes of inks that include dye sublimation pigments alone or in combination with pigment dispersions.

U.S. patent application Ser. No. 18/594,344 describes direct to film printing processes for dye sublimation ink that include the use of clear polymer powders. This application is hereby incorporated by reference in its entirety.

A “dye sublimation pigment”-based ink as used herein is a type of dye sublimation ink that is dispersed and stabilized by polymer dispersants. The dye sublimation pigments herein have the ability to sublime or turn gaseous at a specified temperature (i.e., a sublimation property). A dye sublimation pigment as used herein is a disperse pigment that has a low enthalpy of sublimation compared to other pigments. Sublimating dyes are classified as either low energy, medium energy, or high energy and the classification is dependent on the molecular weights of the dye. Disperse dye sublimation pigments can be used alone or as a mixture.

A “dye”-based ink as used herein contains dyes that are soluble in the solvent they are added to and no longer in crystalline or amorphous form. The dyes are in molecular form and impart color through the absorption of light by its chromophore. Some dyes are able to sublime and others do not. “Solvent” dyes are a type of dye sublimation dye that are dispersed by a solvent. The dye has the ability to sublime or turn gaseous at a specified temperature (i.e., a sublimation property). A solvent dye is a dye that is soluble in organic solvents. Solvent dyes can also have a low enthalpy of sublimation to be used in the printing processes described herein. Solvent dyes can be used alone or as a mixture.

A “pigment dispersion”-based ink as used herein includes organic-based pigments, inorganic-based pigments, or a combination thereof. Pigments are insoluble in the solvent that they are added to and retain their structure. Pigments must be stabilized either electrostatically, sterically or electro-sterically to ensure that particles do not agglomerate in the solvent.

“Pigmented polymer powder” as used herein is a powder that comprises a pigment and a polymer. Pigments are typically incorporated into polymers through either a masterbatch blending, compounding or dry blending process. Pigments include organic-based pigments, inorganic-based pigments, or a combination thereof.

As used herein, “substrate” may include a textile, such as a natural fiber textile, a synthetic fiber textile, or a textile having both natural and synthetic fibers, or a hard surface, such as a rigid surface whose base layer can be a hard organic or inorganic material (e.g., ceramic, metal, wood, or plastic). The hard surface can be uncoated or coated with a polyester polymer coating that acts as a receptive layer for pigments and/or dyes with sublimation properties.

As used herein, the term “hard” as it is used to describe, e.g., a hard polymer-coated or uncoated surface, is understood to be defined as having a Shore A value between 41-100, a Shore D value between 0-100, and/or a Rockwell value between 0-110. The term “soft” as it is used to describe, e.g., a soft textile, is understood to be defined as having a Shore 00 value between 0-80 and/or a Shore A value between 0-40.

The HSV (hue, saturation, and value) color space can be used to describe colors (hues or tints) in terms of their shade (saturation or amount of gray) and brightness value. Hue is the color portion of the model, expressed as a number from 0 to 360 degrees. Saturation describes the amount of gray in a particular color, from 0-100%, or 0-1. Value refers to the brightness or intensity of a color, from 0-100% (or 0-1), where 0% is completely black, and 100% (or 1) is the brightest and reveals the most color.

Thus, as used herein, the term “light” as it is used to describe, e.g., a light-colored textile, polymer coating, and/or pigment, is understood to encompass colors having a high value in the HSV color space (e.g., between about 50-100%, or 0.5-1) and low saturation (e.g., between about 0-50%, or 0-0.5). Examples of light colors include white and pastel colors. The term “dark” as it is used to describe, e.g., a dark-colored textile, polymer coating, and/or pigment is understood to encompass colors having a low value in the HSV color space (e.g., between about 0-50%). Examples of dark colors include black and pure, standard colors (e.g., red, green, blue, yellow, etc.).

### Direct to Film Printing Inkjet Inks with a Pigmented Polymer Powder

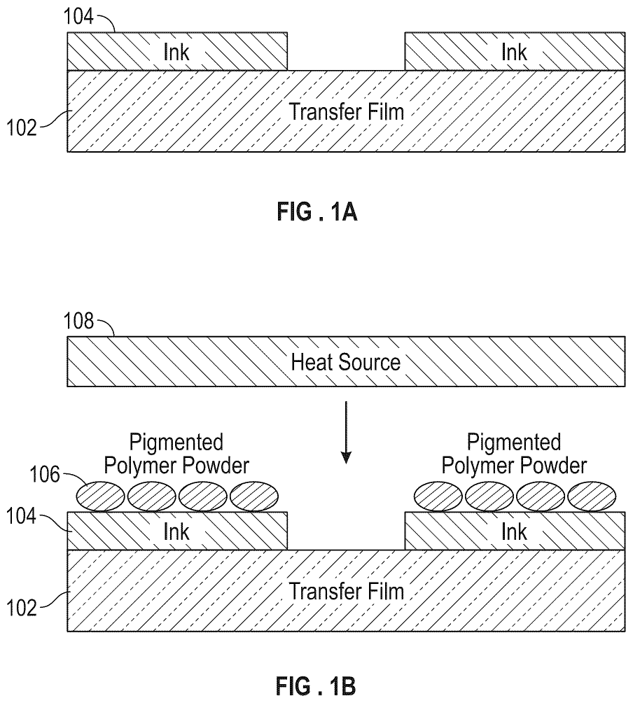

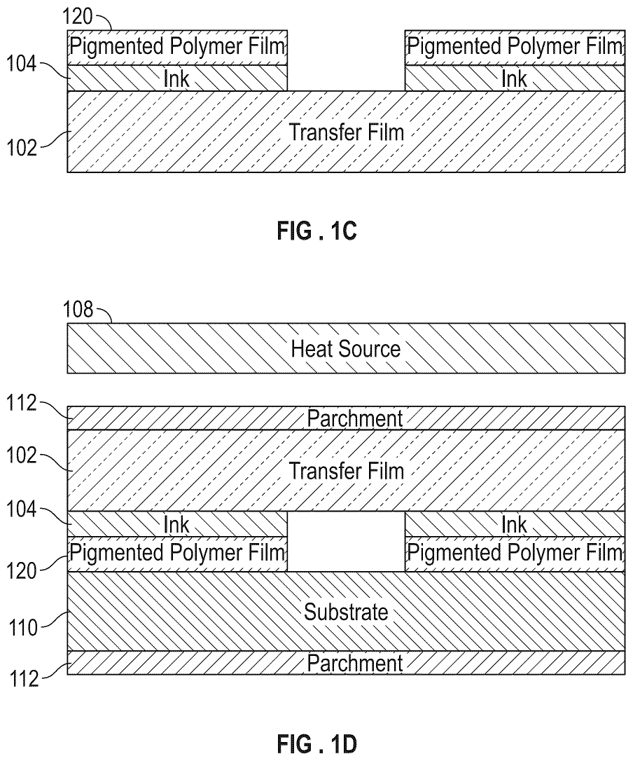

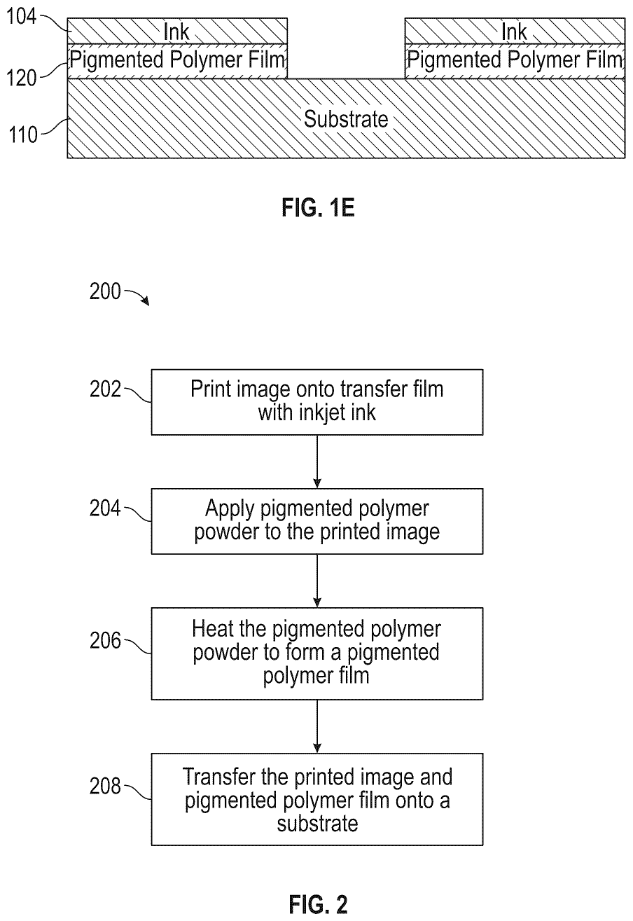

FIGS. 1A-1E show the various steps of a printing process, according to some embodiments provided herein. Specifically, FIG. 1A shows a cross-sectional view of an image printed onto a transfer film using inkjet ink, according to some embodiments. As shown, FIG. 1A includes printed ink 104 layered onto a piece of transfer film 102. In some examples, the printed ink 104 (including, e.g., dye sublimation pigments, pigment dispersions, and/or dyes) is only printed on a portion of an upper surface of the polymer coated film (or transfer film). In this example, some portions of the transfer film 102 remain unprinted, or free from the printed image. The printed ink 104 may be printed using an inkjet printer. In some embodiments, the printed ink 104 is printed onto the transfer film 102 using a printer comprising piezo printheads. In some embodiments, the printed ink 104 is printed onto the transfer film 102 using a printer comprising thermal printheads.

Transfer Film: The transfer film 102 may comprise a polymer coated film. In some embodiments, a polymer coated film can include a cold peel film or a hot peel film. A cold peel film uses a silicone-based film on a surface of a polyethylene terephthalate (PET) plastic backing sheet, while a hot peel transfer film uses a wax-based film on the surface of a PET plastic backing sheet. Cold peel films can be more uniform and provide sharper images. Once transferred, the silicone backing of a cold peel film also helps to improve the washfastness of the product, but the process is longer than that of a hot peel film. A hot peel transfer film is typically slightly less uniform and does not provide the increase in washfastness improvement as compared to a cold peel film, but it can save substantial time in the transfer process.

Suitable commercially available transfer films include, but are not limited to, Uninet DTF Triple Coated Sheets Film, Uninet DTF Triple Coated Film Rolls Film, Kodak FTF (Film to Fabric) Direct to Film Transfer Sheets, Kodak FTF (Film to Fabric) Direct to Film Transfer Sheets, KODACOLOR FTF (Film-to-Fabric) Cold and Hot Film, DTF Station Cut Sheet Film, DTF Station Roll Film, DTF2U 24″ Premium Single-Sided Transfer Film—Cold Peel, DTF2U ULTRA Hot Peel DTF Single-Sided Film (Hybrid/Cold Peel Too), Kingdom DTF Transfer Film Warm and Cold Peel, Kingdom DTF Glossy Cold/Warm, Kingdom DTF Glitter Film Cold Peel, Coldesi DTF Film I Series, Coldesi DTF Film M Series, Coldesi DTF Film S Series, EcoFreen—Premium Plus, EcoFreen—Ultimate, EcoFreen—Super Quality, Forever DTF—Premium Matte, Forever DTF—Matte, Forever DTF—Glossy, Shockline-JP1MFILM75DTFTA3, Shockline—JP1MFILM75DTFCA3, or DTF Superstore—DTG Compatible Film.

Inkjet ink: As described herein, the printed ink 104 can include dye sublimation pigments, pigment dispersions, and/or dyes. For example, the printed ink 104 can be a dye sublimation ink including dye sublimation pigment(s) and pigment dispersion(s). In another example, the printed ink 104 can be a dye sublimation ink including only dye sublimation pigment dispersion(s). In another example, the printed ink 104 can be a pigment ink including pigment dispersion(s) and dye(s). In another example, the printed ink 104 can be a pigment ink including only pigment dispersion(s).

Dye Sublimation Ink: As mentioned above, the printed ink 104 may comprise dye sublimation ink. The dye sublimation inks used with the methods, processes, and printers described herein may include any of the dye sublimation inks described in U.S. application Ser. No. 17/125,740. The dye sublimation inks described in the above-mentioned U.S. application Ser. No. 17/125,740 may be configured such that they do not dry as quickly on the transfer film as compared to other dye sublimation inks. This can maximize the amount of polymer powder that adheres to the printed areas through capillary forces. This can also encourage a more complete transfer of the ink from the polymer coated film to the substrate. However, other dye sublimation inks may also be used with the printed methods and processes described herein. As described herein, the dye sublimation ink can include pigments and/or dyes. For example, the dye sublimation ink can include dye sublimation pigments, alone or in combination with pigment dispersions. In some embodiments, the dye sublimation ink used with the processes and methods described herein can include humectants, surfactants, additives (e.g., biocides/antioxidants/UV absorbers/chelating agents).

The dye sublimation ink can be colored or colorless (i.e., clear). In some examples, the dye sublimation ink is colorless and the pigmented polymer powder described herein is colored. Suitable dye sublimation inks include, but are not limited to: azo, anthraquinone, quinophthalone, styryl, oxazine, xanthene, methine, and azomethine. Among these dyes, examples of a yellow disperse dye include “C. I. Disperse Yellow 51”, 54, 60, 64, 65, 71, 82, 98, 114, 119, 160, 201 and 211. Examples of an orange disperse dye include “C. I. Disperse Orange 25”, 33, 44, and 288. Examples of a red disperse dye include “C. I. Disperse Red 4”, 22, 55, 59, 60, 73, 86, 91, 146, 152, 191, 302, and 364. Examples of a blue disperse dye include “C. I. Disperse Blue 14”, 28, 56, 60, 72, 73, 77, 334, 359, 360 and 366. Other color components are, for example, “C. I. Disperse Brown 27”; “C.I. Disperse Violet 26”, 27, 28 and the like. Examples of solvent dyes include “C. I. Solvent Yellow 16”, 33, 93, and 160; “C. I. Solvent Orange 60”; “C. I. Solvent Red 111”, 155; “C. I. Solvent Violet 31”; “C. I. Solvent Blue 35”, 36, 59, 63, 97, and 104. Preferred dye sublimation inks can include “C. I. Disperse Yellow 54”, 60, 64, 71, 82; “C. I. Disperse Orange 25”, 288; “C. I. Disperse Red 4”, 22, 55, 60, 146, 302, 364; “C. I. Disperse Blue 14”, 28, 56, 72, 334, 359, 360; “C. I. Disperse Violet 28”; “C. I. Solvent Yellow 16”, 33, 93; “C. I. Solvent Orange 60”; “C. I. Solvent Red 111”, 155; “C. I. Solvent Violet 31”; and “C. I. Solvent Blue 35”, 36, 59, 63, 97, 104.

Suitable commercially available dye sublimation inks include, but are not limited to: Mimaki SB53, Mimaki SB54, Mimaki SB210, Mimaki SB300, Mimaki SB310, Mimaki SB320, Mimaki SB410, Mimaki SB411, Mimaki SB420, Mimaki SB610, Mimaki MLSb510, Mimaki MLSb520, Epson T49M for F170 Printers, Epson T53K for F6470 Printers, Epson T46C for F9470/H Printers, Epson T43F for F10070/H Printers, Mutoh DH21 Dye Sublimation Ink, Roland DG Texart SBL3 Dye Sublimation Inks, Hewlett Packard 624 Dye Sublimation Inks, Hewlett Packard 614 Dye Sublimation Inks, Hewlett Packard 636 Dye Sublimation Inks, or Hewlett Packard 638 Dye Sublimation Inks.

Pigment Dispersion: The printed ink 104 may comprise a pigment dispersion. For example, the dye sublimation ink described above can include a pigment dispersion. In another example, a pigment ink used in accordance with the embodiments herein can include a pigment dispersion. The pigment dispersion used in the present disclosure can be an organic-based pigment, inorganic-based pigment, or a combination thereof. Suitable pigments may include, but are not limited to, organic pigments which can include azo pigments, carbon black, polycyclic pigments, chelate dyes, nitro pigments, and nitroso pigments. Suitable pigments can also include, but are not limited to, inorganic pigments which can include titanium dioxide, iron oxides and other metal oxides, cadmium, chromium, antimony, barium, lead, and zinc-based pigments. The pigments can be self-dispersed. The pigments can be combined with surfactants, oligomers, polymers, and/or a combination of dispersants to stabilize the pigments through one or more of steric, electrostatic and/or electro-steric interactions. The pigment dispersions can be less than 1 μm in particle diameter, which can enable the pigment dispersion to be jetted through an inkjet nozzle and can reduce the possibility of clogging. These pigments can be used alone or as a mixture of pigments.

These types of pigments can include, but are not limited to, titanium dioxide or other white pigments, carbon black or other black pigments, red pigments, green pigments, blue pigments, orange pigments, violet pigments, magenta pigments, yellow pigments, cyan pigments, iridescent pigments and/or metallic pigments. Examples of yellow-based pigments may include C.I. Pigment Yellow 1, 2, 3, 4, 5, 6, 7, 10, 11, 12, 13, 14, 14C, 16, 17, 24, 34, 35, 37, 42, 53, 55, 65, 73, 74, 75, 81, 83, 93, 95, 97, 98, 100, 101, 104, 108, 109, 110, 114, 117, 120, 128, 129, 138, 150, 151, 153, 154, 155, and/or 180. Examples of orange-based pigments may include C.I. Pigment Orange 5, 17, 20, 34, 36, 43, 48, 49, 51, 55, 59, 61, 62, 71, 73, and/or 74. Examples of magenta-based pigment may include C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 48, 48:2, 48:3, 48:4, 49, 49:1, 49:2, 50, 51, 52, 52:2, 53:1, 53, 55, 57, 57:1, 60, 60:1, 63:1, 63:2, 64, 64:1, 81, 83, 87, 88, 89, 90, 101, 104, 105, 106, 108, 112, 114, 122, 123, 146, 149, 163, 166, 168, 170, 172, 177, 178, 179, 184, 185, 188, 190, 193, 202, 209, 219, 255, and/or 269. Examples of magenta-based pigments may also include C.I. Pigment Violet 3, 19, 23, 29, 30, 32, 36. 37, 38, 40, and/or 50. Examples of green-based pigment may include C.I. Pigment Green 1, 2, 7, 17, 18, 19, 23, 26, 36, and/or 50. Examples of cyan-based pigment may include C.I. Pigment Blue 1, 2, 3, 15, 15:1, 15:2, 15:3, 15:4, 15:6, 16, 17:1, 22, 25, 56, and/or 60. Examples of cyan-based pigment may also include C.I. Vat Blue 4, 60, and/or 63. Examples of black-based pigment may include C.I. Pigment Black 1, 6, 7, 8, 9, 10, 11. 14, 19, and/or 31. Examples of white-based pigment may include C.I. Pigment White 1, 4, 5, 6, 6:1, 11, 18, and/or 21.

Dyes: The printed ink 104 may comprise a dye. For example, the dye sublimation ink described above can include a dye. In some examples, the printed ink 104 can include a dye and a pigment dispersion. In some embodiments, dyes that are sublimated or evaporated between 150 and 500° F. under atmospheric pressure are suitable for the methods and processes described herein.

Dyes can include but are not limited to direct dyes, acid dyes, basic dyes, reactive dyes, oil soluble dyes, food dyes, vat dyes, soluble vat dyes, reactive disperse dyes and/or disperse dyes, each of which are listed below.

Direct dyes can include, without limitation, C.I. Direct Black 17, C.I. Direct Black 19, C.I. Direct Black 22, C.I. Direct Black 32, C.I. Direct Black 38, C.I. Direct Black 51, C.I. Direct Black 62, C.I. Direct Black 71, C.I. Direct Black 108, C.I. Direct Black 146, C.I. Direct Black 154, C.I. Direct Yellow 12, C.I. Direct Yellow 24, C.I. Direct Yellow 26, C.I. Direct Yellow 44, C.I. Direct Yellow 86, C.I. Direct Yellow 87, C.I. Direct Yellow 98, C.I. Direct Yellow 100, C.I. Direct Yellow 130, C.I. Direct Yellow 142, C.I. Direct Red 1, C.I. Direct Red 4, C.I. Direct Red 13, C.I. Direct Red 17, C.I. Direct Red 23, C.I. Direct Red 28, C.I. Direct Red 31, C.I. Direct Red 62, C.I. Direct Red 79, C.I. Direct Red 81, C.I. Direct Red 83, C.I. Direct Red 89, C.I. Direct Red 227, C.I. Direct Red 240, C.I. Direct Red 242, C.I. Direct Red 243, C.I. Direct Blue 6, C.I. Direct Blue 22, C.I. Direct Blue 25, C.I. Direct Blue 71, C.I. Direct Blue 78, C.I. Direct Blue 86, C.I. Direct Blue 90, C.I. Direct Blue 106, C.I. Direct Blue 199, C.I. Direct Orange 34, C.I. Direct Orange 39, C.I. Direct Orange 44, C.I. Direct Orange 46, C.I. Direct Orange 60, C.I. Direct Violet 47, C.I. Direct Violet 48, C.I. Direct Brown 109, C.I. Direct Green 59.

Acid dyes can include, without limitation, C.I. Acid Black 2, C.I. Acid Black 7, C.I. Acid Black 24, C.I. Acid Black 26, C.I. Acid Black 31, C.I. Acid Black 52, C.I. Acid Black 63, C.I. Acid Black 112, C.I. Acid Black 118, C.I. Acid Black 168, C.I. Acid Black 172, C.I. Acid Black 208, C.I. Acid Yellow 11, C.I. Acid Yellow 17, C.I. Acid Yellow 23, C.I. Acid Yellow 25, C.I. Acid Yellow 29, C.I. Acid Yellow 42, C.I. Acid Yellow 49, C.I. Acid Yellow 61, C.I. Acid Yellow 71, C.I. Acid Red 1, C.I. Acid Red 6, C.I. Acid Red 8, C.I. Acid Red 32, C.I. Acid Red 37, C.I. Acid Red 51, C.I. Acid Red 52, C.I. Acid Red 80, C.I. Acid Red 85, C.I. Acid Red 87, C.I. Acid Red 92, C.I. Acid Red 94, C.I. Acid Red 115, C.I. Acid Red 180, C.I. Acid Red 254, C.I. Acid Red 256, C.I. Acid Red 289, C.I. Acid Red 315, C.I. Acid Red 317, C.I. Acid Blue 9, C.I. Acid Blue 22, C.I. Acid Blue 40, C.I. Acid Blue 59, C.I. Acid Blue 93, C.I. Acid Blue 102, C.I. Acid Blue 104, C.I. Acid Blue 113, C.I. Acid Blue 117, C.I. Acid Blue 120, C.I. Acid Blue 167, C.I. Acid Blue 229, C.I. Acid Blue 234, C.I. Acid Blue 254, C.I. Acid Orange 7, C.I. Acid Orange 19, C.I. Acid Violet 49.

Reactive dyes can include, without limitation, C.I. Reactive Black 1, C.I. Reactive Black 5, C.I. Reactive Black 8, C.I. Reactive Black 13, C.I. Reactive Black 14, C.I. Reactive Black 23, C.I. Reactive Black 31, C.I. Reactive Black 34, C.I. Reactive Black 39, C.I. Reactive Yellow 2, C.I. Reactive Yellow 3, C.I. Reactive Yellow 13, C.I. Reactive Yellow 15, C.I. Reactive Yellow 17, C.I. Reactive Yellow 18, C.I. Reactive Yellow 23, C.I. Reactive Yellow 24,C.I. Reactive Yellow 37, C.I. Reactive Yellow 42, C.I. Reactive Yellow 57, C.I. Reactive Yellow 58, C.I. Reactive Yellow 64, C.I. Reactive Yellow 75, C.I. Reactive Yellow 76, C.I. Reactive Yellow 77, C.I. Reactive Yellow 79, C.I. Reactive Yellow 81, C.I. Reactive Yellow 84, C.I. Reactive Yellow 85, C.I. Reactive Yellow 87, C.I. Reactive Yellow 88, C.I. Reactive Yellow 91, C.I. Reactive Yellow 92, C.I. Reactive Yellow 93, C.I. Reactive Yellow 95, C.I. Reactive Yellow 102, C.I. Reactive Yellow 111, C.I. Reactive Yellow 115, C.I. Reactive Yellow 116, C.I. Reactive Yellow 130, C.I. Reactive Yellow 131, C.I. Reactive Yellow 132, C.I. Reactive Yellow 133, C.I. Reactive Yellow 135, C.I. Reactive Yellow 137, C.I. Reactive Yellow 139, C.I. Reactive Yellow 140, C.I. Reactive Yellow 142, C.I. Reactive Yellow 143, C.I. Reactive Yellow 144, C.I. Reactive Yellow 145, C.I. Reactive Yellow 146, C.I. Reactive Yellow 147, C.I. Reactive Yellow 148, C.I. Reactive Yellow 151, C.I. Reactive Yellow 162, C.I. Reactive Yellow 163, C.I. Reactive Red 3, C.I. Reactive Red 13, C.I. Reactive Red 16, C.I. Reactive Red 21, C.I. Reactive Red 22, C.I. Reactive Red 23, C.I. Reactive Red 24, C.I. Reactive Red 29, C.I. Reactive Red 31, C.I. Reactive Red 33, C.I. Reactive Red 35, C.I. Reactive Red 45, C.I. Reactive Red 49, C.I. Reactive Red 55, C.I. Reactive Red 63, C.I. Reactive Red 85, C.I. Reactive Red 106, C.I. Reactive Red 109, C.I. Reactive Red 111, C.I. Reactive Red 112, C.I. Reactive Red 113, C.I. Reactive Red 114, C.I. Reactive Red 118, C.I. Reactive Red 126, C.I. 40 Reactive Red 128, C.I. Reactive Red 130, C.I. Reactive Red 131, C.I. Reactive Red 141, C.I. Reactive Red 151, C.I. Reactive Red 170, C.I. Reactive Red 171, C.I. Reactive Red 174, C.I. Reactive Red 176, C.I. Reactive Red 177, Reactive Red 183, C.I. Reactive Red 184, C.I. Reactive Red 186, C.I. Reactive Red 187, C.I. Reactive Red 188, C.I. Reactive Red 190, C.I. Reactive Red 193, C.I. Reactive Red 194, C.I. Reactive Red 195, C.I. Reactive Red 196, C.I. Reactive Red 200, C.I. Reactive Red 201, C.I. Reactive Red 202, C.I. Reactive Red 204, C.I., Reactive Red 206, C.I. Reactive Red 218, C.I. Reactive Red 221, C.I. Reactive Blue 2, C.I. Reactive Blue 3, C.I. Reactive Blue 5, C.I. Reactive Blue 8, C.I. Reactive Blue 10, C.I. Reactive Blue 13, C.I. Reactive Blue 14, C.I. Reactive Blue 15, C.I. Reactive Blue 18, C.I. Reactive Blue 19, C.I. Reactive Blue 21, C.I. Reactive Blue 25, C.I. Reactive Blue 27, C.I. Reactive Blue 28, C.I. Reactive Blue 38, C.I. Reactive Blue 39, C.I. Reactive Blue 40, C.I. Reactive Blue 41, C.I. Reactive Blue 49, C.I. Reactive Blue 52, C.I. Reactive Blue 63, C.I. Reactive Blue 71, C.I. Reactive Blue 72, C.I. Reactive Blue 74, C.I. Reactive Blue 75, C.I. Reactive Blue 77, C.I. Reactive Blue 78, C.I. Reactive Blue 79, C.I. Reactive Blue 89, C.I. Reactive Blue 100, C.I. Reactive Blue 101, C.I. Reactive Blue 104, C.I. Reactive Blue 104, C.I. Reactive Blue 105, C.I. Reactive Blue 119, C.I. Reactive Blue 122, C.I. Reactive Blue 147, C.I. Reactive Blue 158, C.I. Reactive Blue 160, C.I. Reactive Blue 162, C.I. Reactive Blue 166, C.I. Reactive Blue 166, C.I. Reactive Blue 169, C.I. Reactive Blue 170, C.I. Reactive Blue 171, C.I. Reactive Blue 172, C.I. Reactive Blue 173, C.I. Reactive Blue 174, C.I. Reactive Blue 176, C.I. Reactive Blue 179, C.I. Reactive Blue 184, C.I. Reactive Blue 190, C.I. Reactive Blue 191, C.I. Reactive Blue 194, C.I. Reactive Blue 195, C.I. Reactive Blue 198, C.I. Reactive Blue 204, C.I. Reactive Blue 211,C.I. Reactive Blue 216, C.I. Reactive Blue 217, C.I. Reactive Orange 5, C.I. Reactive Orange 7, C.I. Reactive Orange 11, Reactive Orange 12, C.I. Reactive Orange 13, C.I. Reactive Orange 15, C.I. Reactive Orange 16, C.I. Reactive Orange 35, C.I. Reactive Orange 45, C.I. Reactive Orange 46, C.I. Reactive Orange 56, C.I. Reactive Orange 62, C.I. Reactive Orange 70, C.I. Reactive Orange 72, C.I. Reactive Orange 15 74, C.I. Reactive Orange 82, C.I. Reactive Orange 84, C.I. Reactive Orange 87, C.I. Reactive Orange 91, C.I. Reactive Orange 92, C.I. Reactive Orange 93, C.I. Reactive Orange 95, C.I. Reactive Orange 97, C.I. Reactive Orange 99, C.I. Reactive Violet 1, C.I. Reactive Violet 4, C.I. Reactive 20 Violet 5, C.I. Reactive Violet 6, C.I. Reactive Violet 22, C.I. Reactive Violet 24, C.I. Reactive Violet 33, C.I. Reactive Violet 36, C.I. Reactive Violet 38, C.I. Reactive Green 5, C.I. Reactive Green 8, C.I. Reactive Green 12, C.I. Reactive Green 15, C.I. Reactive Green 19, C.I. Reactive Green 23, 25 C.I. Reactive Brown 2, C.I. Reactive Brown 7, C.I. Reactive Brown 8, C.I. Reactive Brown 9, C.I. Reactive Brown 11, C.I. Reactive Brown 16, C.I. Reactive Brown 17, C.I. Reactive Brown 18, C.I. Reactive Brown 21, C.I. Reactive Brown 24, C.I. Reactive Brown 26, C.I. Reactive Brown 31, C.I. Reactive Brown 32, C.I. Reactive Brown 33, etc., (Basic Dyes) C.I. Basic Black 2, C.I. Basic Red 1, C.I. Basic Red 2, C.I. Basic Red 9, C.I. Basic Red 12, C.I. Basic Red 13, C.I. Basic Red 14, C.I. Basic Red 27, C.I. Basic Blue 1, C.I. Basic Blue 35 3, C.I. Basic Blue 5, C.I. Basic Blue 7, C.I. Basic Blue 9, C.I. Basic Blue 24, C.I. Basic Blue 25, C.I. Basic Blue 26, C.I. Basic Blue 28, C.I. Basic Blue 29, C.I. Basic Violet 7, C.I. Basic Violet 14, C.I. Basic Violet 27, C.I. Food Black 1, C.I. Food Black 2.

Oil-soluble dyes can include, without limitation, C.I. Solvent Yellow 1, C.I. Solvent Yellow 2, C.I. Solvent Yellow 3, C.I. Solvent Yellow 13, C.I. Solvent Yellow 19, C.I. Solvent Yellow 22, C.I. Solvent Yellow 29, C.I. Solvent Yellow 36, C.I. Solvent Yellow 37, C.I. Solvent Yellow 38, C.I. Solvent Yellow 39, C.I. Solvent Yellow 40, C.I. Solvent Yellow 43, C.I. Solvent Yellow 44, C.I. Solvent Yellow 45, C.I. Solvent Yellow 47, C.I. Solvent Yellow 62, C.I. Solvent Yellow 63, C.I. Solvent Yellow 71, C.I. Solvent Yellow 76, C.I. Solvent Yellow 81, C.I. Solvent Yellow 85, C.I. Solvent Yellow 86, etc., C.I. Solvent Red 35, C.I. Solvent Red 36, C.I. Solvent Red 37, C.I. Solvent Red 38, C.I. Solvent Red 39, C.I. Solvent Red 40, C.I. Solvent Red 58, C.I. Solvent Red 60, C.I. Solvent Red 65, C.I. Solvent Red 69, C.I. Solvent Red 81, C.I. Solvent Red 86, C.I. Solvent Red 89, C.I. Solvent Red 92, C.I. Solvent Red 97, C.I. Solvent Red 99, C.I. Solvent Red 100, C.I. Solvent Red 109, C.I. Solvent Red 118, C.I. Solvent Red 119, C.I. Solvent Red 122, etc., C.I. Solvent Blue 14, C.I. Solvent Blue 24, C.I. Solvent Blue 26, C.I. Solvent Blue 34, C.I. Solvent Blue 37,C.I. Solvent Blue 39, C.I. Solvent Blue 42, C.I. Solvent Blue 43, C.I. Solvent Blue 45, C.I. Solvent Blue 48, C.I. Solvent Blue 52, C.I. Solvent Blue 53, C.I. Solvent Blue 55, C.I. Solvent Blue 59, C.I. Solvent Blue 67, etc., C.I. Solvent Black 5, C.I. Solvent Black 8,C.I. Solvent Black 14, C.I. Solvent Black 17, C.I. Solvent Black 19, C.I. Solvent Black 20, C.I. Solvent Black 22, C.I. Solvent Black 24, C.I. Solvent Black 26, C.I. Solvent Black 28, C.I. Solvent Black 43.

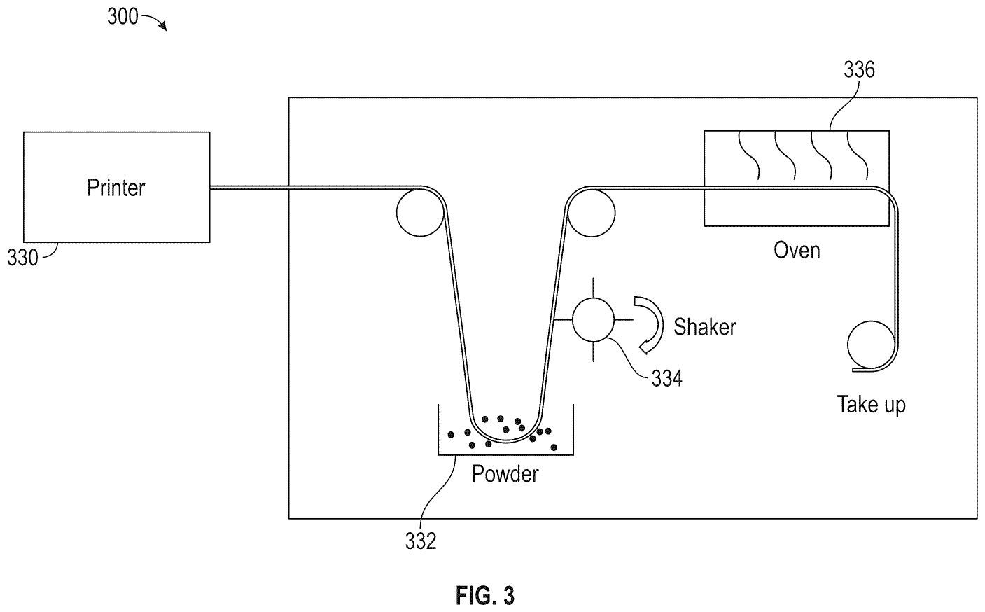

FIG. 1B shows a cross-section view of pigmented polymer powder 106 applied to the printed ink 104 of FIG. 1A and heated, according to some embodiments. The pigmented polymer powder 106 may be applied manually. For example, the pigmented polymer powder 106 may be applied by passing the printed film through a bed of the pigmented polymer powder 106 in a container. The pigmented polymer powder 106 may also be applied via printer 330 in enclosed equipment, in which the printed film is passed through a bed 332 of pigmented polymer powder 106. This process is depicted in FIG. 3 and may include a shaker 334 to remove any excess powder, which can then pass the powdered printed film through an oven 336. By using an enclosed system, exposure to dust from the pigmented polymer powder 106 may be minimized. In some embodiments, the pigmented polymer powder 106 specifically provides a light, opaque color to the printed ink 104, allowing the printed ink 104 to be transferred onto a dark-colored substrate such that the light-colored printed ink 104 is visible against the dark color of the substrate. As shown, FIG. 1B includes the printed ink 104 on the transfer film 102. Layered on top of the printed ink 104 image is a pigmented polymer powder 106. The pigmented polymer powder 106 adheres to the printed ink 104, particularly right after the printed ink 104 has been printed onto the transfer film 102 and is still warm. After the pigmented polymer powder 106 has been applied to the printed ink 104, a heat source 108 (e.g., a heat press/calendar) may be applied to the pigmented polymer powder 106.

As shown, the pigmented polymer powder 106 is applied to the printed image (i.e., printed ink 104 on the transfer film 102) such that the pigmented polymer powder 106 is only applied to the printed ink 104 itself (i.e., the printed inkjet ink) and not the exposed transfer film 102. Particulates of the pigmented polymer powder 106 adhere to the printed ink 104 on the transfer film. In some embodiments, to achieve this (i.e., pigmented polymer powder 106 applied only to the printed ink 104 and not the exposed transfer film 102) may include removing excess, non-adhered pigmented polymer powder 106 from the transfer film 102.

In some embodiments, melting the pigmented polymer powder 106 may include placing the printed film (i.e., printed ink 104 on the transfer film 102) into an oven. In some embodiments, melting the pigmented polymer powder 106 may include applying a heat source 108 to the printed and powdered face of the transfer film 102. In some embodiments, melting the pigmented polymer powder 106 can include placing or hovering the powdered and printed transfer film underneath or on top of a heat source 108 until the powder adequately melts. The heat source 108 can include a conductive heater, a convective heater, a radiative heater, or a combination thereof. In some embodiments, the heat source 108 is applied at 250-350 degrees Fahrenheit for 30 to 120 seconds. For example, a polymer powder with a melting point at 255 degrees F. can be melted using a heat press at 350 for 30 s to 1 minute. In another example, a conveyor with a heater can melt a polymer powder at 290 degrees F. for 2 minutes. In some examples, the heat source 108 is applied at 200-280 degrees F. for 10-20 seconds. In some examples, the heat source 108 is applied at 200-280 degrees F. for 2 minutes. In some embodiments, the heat source 108 is applied at 100-500, 100-400, 150-350, 200-300, or 230-280 degrees Fahrenheit. In some embodiments, the heat source 108 is applied at less than or equal to 500, 400, 380, 350, 320, 300, 290, 280, 270, 260, 250, 240, 230, 220, or 210 degrees Fahrenheit. In some embodiments, the heat source 108 is applied at greater than or equal to 200, 210, 220, 230, 240, 250, 260, 270, 280, 290, 300, 320, 350, 380, 400, or 450 degrees Fahrenheit. In some embodiments, the heat source 108 is applied for 1-180, 1-120, 1-90, 1-60, 5-30, 5-25, or 10-20 seconds. In some embodiments, the heat source 108 is applied for less than or equal to 180, 120, 90, 60, 55, 50, 45, 40, 35, 30, 25, 20, 15, 10, or 5 seconds. In some embodiments, the heat source 108 is applied for greater than or equal to 1, 5, 10, 15, 20, 25, 30, 35, 40, 45, 50, 55, 60, 65, 70, 75, 80, 85, 90, 95, or 120 seconds.

Pigmented Polymer Powder: The pigmented polymer powder 106 can comprise any desired color, depending on the specific pigment, organic or inorganic, that is incorporated into the pigmented polymer powder 106. In some examples, the pigmented polymer powder 106 is white. The pigmented polymer powder 106 comprises the specific pigment combined with a polymer. The polymer is compounded with a suitable pigment (e.g., any of the typical pigments described above) at a selected percentage required and then formed to a pellet. The pellets can then be cryogenically ground to produce the appropriately sized particulates for use in the disclosed printing methods and processes. More specifically, the pellets can be formed through a masterbatch compounding process. The polymer(s) of the pigmented polymer powder 106 are received from the manufacturer in pellet form. The polymer pellets are mixed with an inorganic or organic pigment and placed in an extruder. The mixture can then be heated in the extruder and mixed into a liquid. Once properly homogenized, the mixture can then be pushed through the die heads to form plastic strands which are water cooled and then cut to form new pellets.

In some embodiments, the pigmented polymer powder 106 particulates have a particle size (i.e., particulate diameter) of 100-200 microns, or 50-500 microns. In some embodiments, the pigmented polymer powder 106 particulates have a particulate size (i.e., particulate diameter) less than or equal to 500, less than or equal to 400, less than or equal to 300, less than or equal to 200, less than or equal to 100, or less than or equal to 75 microns. In some embodiments, the pigmented polymer powder 106 particulates have a particulate size (i.e., particulate diameter) greater than or equal to 50, greater than or equal to 75, greater than or equal to 100, greater than or equal to 200, greater than or equal to 300, or greater than or equal to 400 microns. Below 10 microns, the particulates become an inhalation hazard and proper safety and engineering controls must be used. The particle size (i.e., particulate diameter) may be measured by sieving, dynamic or light scattering, or image analysis.

In some embodiments, the pigmented polymer powder 106 can include 1-50, 5-25, 10-20, or 25-35 wt. % pigment. The pigmented polymer powder 106 can include less than or equal to 50, 45, 40, 35, 30, 25, 20, 15, 10, or 5 wt. % pigment. In some embodiments, the pigmented polymer power 106 can include greater than or equal to 1, 5, 10, 15, 20, 25, 30, 25, 40, or 45 wt. % pigment. In some examples, the pigmented polymer powder includes between 2-20 wt. %, 4-16 wt. %, or 8-12 wt. % pigment. In some examples, the pigmented polymer powder includes greater than or equal to 2, 4, 6, 8, 10, 12, 14, 16, or 18 wt. % pigment. In some examples, the pigmented polymer powder includes less than or equal to 4, 6, 8, 10, 12, 14, 16, 18, or 20 wt. % pigment.

The pigmented polymer powder 106 can include 50-99, 80-90, or 65-75 wt. % polymer. In some embodiments, the pigmented polymer powder 106 may comprise less than or equal to 99, 95, 90, 85, 80, 75, 70, 65, 60, or 55 wt. % polymer. In some embodiments, the pigmented polymer powder 106 may comprise greater than or equal to 50, 55, 60, 65, 70, 75, 80, 85, 90, or 95 wt. % polymer.

In some examples, the pigmented polymer powder 106 comprises one or more of polyethylene terephthalate, polybutylene terephthalate, polyethylene, naphthalate, polytrimethylene, terephthalate, polycaprolactone, polylactic acid, polyhydroxybutyrate, polyglycolide, or poly(ethylene adipate), polyurethanes, polyacrylics, polyvinylchlorides, polyvinylacetates, polyethylene, polypropylene, polycarbonate, polystyrene, ABS, polyamides, PEEK, poly(ethylene terephthalate), poly(ether sulphone), and/or co/ter-polymers thereof. In some embodiments, the polymer powder comprises one or more of acrylics, aramids, chlorinated polymers, elastanes, elastodienes, fluorinated polymers, polyurethanes, styrene acrylics, polyvinyl chlorides, polyolefins, polystyrenes, acrylonitrile butadiene styrenes, polyacetates, polyurethane acrylics, polyamides, polyethylenes, polyimides, polyethers, polycarbonates, polyvinylalcohols, polyesters, polyethylene terephthalate, polybutylene terephthalate, polyethylene naphthalate, polytrimethylene terephthalate, polycaprolactone, polylactic acid, polyhydroxybutyrate, polyglycolide, and/or poly(ethylene adipate), and/or any other natural or synthetic polymer.

The polymer used in the pigmented polymer powder 106 can include, but is not limited to: polyester, acrylic, aramid, chlorinated polymer, elastane, elastodiene, fluorinated polymer, polyurethane, polyacetate, styrene acrylic, PVC, polyolefin, polystyrene, ABS, polyacetate, polyurethane acrylic, polyamide, polyethylene, polyimide, polyvinylalcohol or any other type of natural or synthetic polymer and combinations thereof to form copolymers. In some embodiments, the pigmented polymer powder 106 used herein can comprise one or more of a polyurethane or a polyester. In some embodiments, the pigmented polymer powder 106 used herein may comprise one or more polyurethanes.

A pigmented polymer powder 106 comprising a polyurethane and/or a polyester can achieve an appropriate balance of adhesion (i.e., to the substrate) and elongation (i.e., the ability of the product to stretch without breaking) to maintain the elasticity of a textile substrate to which the image is printed, and yet still have the toughness to pass the industry standard for crock testing. Elongation may be measured with the tensile strength, which can provide a quantitative value of force for its breaking strength and max elongation before breaking (ASTM D751). A visual qualitative analysis can also be used to see if the image breaks. A suitable polymer can be stretched to its breaking strength without the image cracking.

Adhesion of the inkjet ink to the pigmented polymer is also as important as the adhesion of the pigmented polymer to the substrate when the printed image is transferred to the substrate (as shown in FIGS. 1D, 1E). These desired properties are dictated by the type of polyol and bifunctional isocyanates used in the production of the polyurethane and the type of diol and dicarboxylic acid used in the polycondensation reaction of the manufacture of polyester. Polymers that are not suitable for the pigmented polymer powder 106 include polymers that are relatively brittle (and thus don't stretch well). Other unsuitable polymers are those that have poor transferability and/or poor washability. For example, one family of polymers that are unsuitable for the pigmented polymer powder 106 include polyvinylalcohols, which are water soluble (and thus wash off) and have high melting points (thus leading to poor transfer to the substrate).

Suitable commercially available polyesters include, but are not limited to: PES T3 (Fixatti), PES T4/374 (Fixatti), PES T5 (Fixatti),PES T6/376 (Fixatti), PES T7/386 (Fixatti), PES 386 F (Fixatti), PES T14 (Fixatti), PES E20 (Fixatti), PES 3320 (Fixatti), PES 3230 (Fixatti), PES 3730 (Fixatti), PES 3820 MC (Fixatti), PES 3825 DC (Fixatti), PES 3820 MC (Fixatti), PES 3825 DC (Fixatti), Rucote 5001 (Stepan), Rucote 5006 (Stepan), Rucote 109 (Stepan), Rucote 9900 (Stepan), Rucote 117 (Stepan), Rucote 5500 (Stepan), Rucote XP 5500 (Stepan), Rucote 9008 (Stepan), Rucote 561 (Stepan), Rucote 106 (Stepan), Rucote 121 (Stepan), Rucote 118 (Stepan), Rucote 921 (Stepan), Rucote 108 (Stepan), Rucote 104 (Stepan), Rucote 102 (Stepan), Rucote 921 (Stepan), Rucote 123 (Stepan), Rucote 561 (Stepan), Rucote 560 (Stepan), Rucote 562 (Stepan), Rucote 570 (Stepan), Rucote 107 (Stepan), Rucote 9011 (Stepan), Rucote 9010 (Stepan), Rucote 5016 (Stepan), Rucote XP 9014 (Stepan), Rucote 9400 (Stepan), Rucote 9006 (Stepan), Rucote 9110 (Stepan), Accucomp PET 008L (Lyondellbasell), Icorene N9201 (Lyondellbasell), Icorene N9204 (Lyondellbasell), Icorene N9206 (Lyondellbasell), Icorene N9207 (Lyondellbasell), Matrixx 80M7451 (Lyondellbasell), Matrixx 80S7150 (Lyondellbasell), Matrixx 80S7351 (Lyondellbasell), Matrixx 80S7451 (Lyondellbasell), Matrixx 81N7004 (Lyondellbasell), MatrixX 85S7451 (Lyondellbasell), QR Resin QR 3000 (Lyondellbasell), QR Resin QR 3000 GF30 (Lyondellbasell), Schuladur E GF 30 FR5 (Lyondellbasell), Schuladur E GF 35 Schawrz (Lyondellbasell), Chuladur E GF 50 (Lyondellbasell), Primatop PET GP68-HP (Amco Polymers), Primatop PET GP80 (Amco Polymers), InElec PCT7011AS (Americhem), InElec PCT7011AS10 (Americhem), InElec PCT7031AS (Americhem), Petra 130 (BASF), Petra 130 (BASF), BK112 (BASF), Petra 130FR (BASF), Petra 130 FR BK 112 (BASF), Petra 140 (BASF), Petra 230 BK112 (BASF), Petra 330 FR (BASF), Petra 330 FR BK112 (BASF), Petra 7010 BK5830 (BASF), Impet 2700 GV1/30 (Celanese), Impet 2700 GV1/30 (Celanese), Impet 2700 GV1/45, (Celanese), Impet 2700A GV1/30FC (Celanese), Impet 330R (Celanese), Impet 340R (Celanese), Impet 5206HG (Celanese), Impet 830R (Celanese), Impet HD250 (Celanese), Eastar EN058 Natural (Eastman Chemical Company), LNP Colorcomp WQ117945 (Sabic), DAK Americas Laser+® C91A PET, DAK Americas Laser+® MB912 PET, DAK Americas Laser+® 7000 (C91A) PET, DAK Americas Laser+® HP806 (B93A) PET, DAK Americas Laser+® B90A PET, DAK Americas Laser+® B90B PET, DAK Americas Laser+® C C61A PET, DAK Americas Laser+® C E61A PET, DAK Americas Laser+® C K62A PET, DAK Americas Laser+® C 4800 B66A PET, DAK Americas Laser+® C 9000 (B64A) PET, DAK Americas Laser+® C 9921 (F65A) PET, DAK Americas Laser+® C 61803 (E67A) PET, DAK Americas Laser+® C (C60A) PET, DAK Americas Laser+® C (E60A) PET, DAK Americas Laser+® HS D59A PET, DAK Americas Laser+® HS CF746A (D53A) PET, DAK Americas Laser+® HS AD600A PET, DAK Americas Laser+® HS Ti818 (G51A) PET, DAK Americas Laser+® W L44A PET, DAK Americas Laser+® W L44B PET, DAK Americas Laser+® W P45A PET, DAK Americas Laser+® W 4000 K42A PET, DAK Americas Laser+® W PJ002 F43A PET, DAK Americas Laser+® W Ti844 P46A PET, DAK Americas Laser+® W L40A PET, DAK Americas Laser+® W L40B PET, DAK Americas Laser+® W P41A PET, DSM Arnite® AM8527 (G) PET-GF, 3D Printing Grade, DSM Arnite® ID 3040 PET, 3D Printing Grade, DSM Arnite® AV2 390 XT PET GF50, DSM Arnite® AV2 390 XL PET GF50, DSM Arnite® AV2 370 XT PET-GF35, DSM Arnite® AV2 370 XL-T PET-GF35, DSM Arnite® AV2 370 XL PET-GF35, DSM Arnite® AV2 370 HF PET-GF35, and DSM Arnite® A02 307 PET.

Suitable commercially available polyurethanes include, but are not limited to: TPU 4046 (Fixatti), TPU 4073 RSL (Fixatti), TPU 529 (Fixatti), TPU 4126 (Fixatti), TPU 5045 (Fixatti), PCL 352 (Fixatti), PCL 5110 (Fixatti), TPU 6040 (Fixatti), TPU 6120 (Fixatti), TPU 6005 (Fixatti), TPU 6012 (Fixatti), TPU 6220 (Fixatti), TPU 6511 (Fixatti), TPU 8086 COLOUR (Fixatti), TPU 8086 NATURAL (Fixatti), TPU 8093 COLOUR (Fixatti), TPU 8093 NATURAL (Fixatti), Elastollan 1170 A (BASF), Elastollan 1175 A W (BASF), Elastollan 1180 A (BASF), Elastollan 1185 A W (BASF), Elastollan 1185 A (BASF), Elastollan 1185 A M (BASF), Elastollan 1185 A WM (BASF), Elastollan 1190 A (BASF), Elastollan 1195 A (BASF), Elastollan 1198 A (BASF), Elastollan 1154 D (BASF), Elastollan 1160 D (BASF), Elastollan 1164 D (BASF), Elastollan 1174 D (BASF), Elastollan 1298 A U (BASF), Elastollan 1254 D U (BASF), Elastollan 1260 D U (BASF), Elastollan 1264 D U (BASF), Elastollan C 60 AP (BASF), Elastollan C 78 A (BASF), Elastollan C 80 A (BASF), Elastollan C 85 A (BASF), Elastollan C 88 A (BASF), Elastollan C 90 A (BASF), Elastollan C 95 A (BASF), Elastollan C 98 A (BASF), Elastollan C 59 D (BASF), Elastollan C 60 D (BASF), Elastollan C 64 D (BASF), Elastollan C 74 D (BASF), DSM Biomedical Elasthane 75D, DSM Biomedical Elasthane 80A, or any of the Desmopan® TPU grades by Covestro.

Any color pigment may be used in the pigmented polymer powder. For example, if black pigment is used, the black pigment can be any commercially available black pigment that provides acceptable optical density and print characteristics. Such black pigments can be manufactured by a variety of known methods such as channel methods, contact methods, furnace methods, acetylene methods, or thermal methods.

In some examples, the pigmented polymer powder is white pigmented polymer powder. Suitable white pigments can include any typical white pigment used in the industry (e.g., titanium dioxide (rutile, anatase, brookite etc.), zinc sulfide, zinc oxide, lithopones, lead carbonate, antimony (III) oxide, calcium carbonate, barium sulfate, talc, salts and ester of titanic acid, zirconium oxide (zirconia), aluminum phosphate, aluminum oxide, magnesium oxide, silicon dioxide and similar materials and combinations of such materials). Hollow sphere or other porous polymeric particles can also be used in combination with above listed materials. In some examples, white pigmented polymer powder may be applied to a colorless (or clear) ink to print white, e.g., on a dark-colored substrate.

If a colored pigment is used, any number (single or combination) of pigments can be selected for inclusion in the polymer pellets of the present disclosure, such as cyan, magenta, yellow, blue, orange, green, pink, etc. Suitable organic pigments include, for example, azo pigments including diazo pigments and monoazo pigments, polycyclic pigments (e.g., phthalocyanine pigments such as phthalocyanine blues and phthalocyanine greens, perylene pigments, perynone pigments, anthraquinone pigments, quinacridone pigments, dioxazine pigments, thioindigo pigments, isoindolinone pigments, pyranthrone pigments, and quinophthalone pigments), insoluble dye chelates (e.g., basic dye type chelates and acidic dye type chelate), nitropigments, nitroso pigments, anthanthrone pigments such as Pigment Red 168, and the like. Representative examples of phthalocyanine blues and greens include copper phthalocyanine blue, copper phthalocyanine green and derivatives thereof (Pigment Blue 15 and Pigment Green 36). Representative examples of quinacridones include Pigment Orange 48, Pigment Orange 49, Pigment Red 282, Pigment Red 122, Pigment Red 192, Pigment Red 202, Pigment Red 206, Pigment Red 207, Pigment Red 209, Pigment Violet 19 and Pigment Violet 42. Representative examples of anthraquinones include Pigment Red 43, Pigment Red 194, Pigment Red 177, Pigment Red 216 and Pigment Red 226. Representative examples of perylenes include Pigment Red 123, Pigment Red 149, Pigment Red 179, Pigment Red 190, Pigment Red 189 and Pigment Red 224. Representative examples of thioindigoids include Pigment Red 86, Pigment Red 87,Pigment Red 88, Pigment Red 181, Pigment Red 198, Pigment Violet 36, and Pigment Violet 38. Pigment 150 is another example of an azo pigment. Representative examples of heterocyclic yellows include Pigment Yellow 1, Pigment Yellow 3, Pigment Yellow 12, Pigment Yellow 13, Pigment Yellow 14, Pigment Yellow 17, Pigment Yellow 65, Pigment Yellow 73, Pigment Yellow 74, Pigment Yellow 90, Pigment Yellow 110, Pigment Yellow 117, Pigment Yellow 120, Pigment Yellow 128, Pigment Yellow 138, Pigment Yellow 150, Pigment Yellow 151, Pigment Yellow 155, and Pigment Yellow 213. Such pigments are commercially available in powder, press cake, or dispersion form from a number of sources. In one example, pigment blends or dispersions from various manufacturers can be used.

FIG. 1C shows a cross-sectional view of a pigmented polymer film 120 formed from a pigmented polymer powder and layered on top of the printed image of FIG. 1A, according to some embodiments. As explained with reference to FIG. 1B, heat may be applied to the pigmented polymer powder 106 of FIG. 1B to melt it. When melted, the pigmented polymer powder 106 forms a pigmented polymer film 120 layered on top of the printed ink 104. When the pigmented polymer powder 106 is melted by heat application, most of the volatile components of the inkjet ink are removed (e.g., water, humectants).

In some embodiments, the pigmented polymer film 120 is directly overlying the printed ink 104. In some embodiments, the pigmented polymer film 120 does not come in contact with the transfer film 102 at all. In some embodiments, the pigmented polymer film 120 overlies the transfer film 102 and therefore comes in contact with both the printed ink 104 and the transfer film 102.

FIG. 1D shows a cross-sectional view of a transferring assembly, according to some embodiments. Here, the transfer film 102 layered with the printed ink 104 and pigmented polymer film 120 is inverted and layered onto a substrate 110 (e.g., natural fiber textile, synthetic fiber textile, natural/synthetic fiber textile, hard coated or uncoated surface, etc.). In some embodiments, this layered transferring assembly (i.e., substrate—pigmented polymer powder—printed image—transfer film) is sandwiched between two layers of parchment paper 112. A heat source 108, such as a heat press, may be applied to the transferring assembly to transfer the printed ink 104 with the pigmented polymer film 120 to the substrate 110.

In some embodiments, the heat source 108 is applied to the assembly at 392 degrees Fahrenheit for 5 seconds. In some embodiments, the heat source 108 is applied to the assembly at 300 degrees Fahrenheit for 8 seconds. In some embodiments, the heat source 108 is applied at 100-500, 250-450, 275-325, 350-400, 375-425, or 390-395 degrees Fahrenheit. In some embodiments, the heat source 108 is applied at less than or equal to 500, 475, 450, 445, 440, 435, 430, 425, 420, 415, 410, 405, 400, 395, 390, 385, 380, 375, 370, 365, 360, 355, 350, 345, 340, 335, 330, 325, 320, 315, 310, or 305 degrees Fahrenheit. In some embodiments, the heat source 108 is applied at greater than or equal to 100, 125, 150, 175, 200, 225, 250, 260, 270, 275, 280, 285, 290, 295, 300, 325, 350, 355, 360, 365, 370, 375, 380, 385, 390, 395, 400, 405, 410, 415, 420, 425, 430, 435, 440, or 445 degrees Fahrenheit. In some embodiments, the heat source 108 is applied for 1-60, 1-30, 1-15, or 1-10 seconds. In some embodiments, the heat source 108 is applied for less than or equal to 60, 55, 50, 45, 40, 35, 30, 25, 20, 15, 10, or 5 seconds. In some embodiments, the heat source 108 is applied for greater than or equal to 1, 5, 10, 15, 20, 25, 30, 35, 40, 45, 50, 55, 60, 65, 70, 75, 80, 85, 90, or 95 seconds.

FIG. 1E shows a cross-sectional view of a printed substrate, according to some embodiments. After the heat source 108 (e.g., a heat press) has been applied to the transferring assembly, as described above with respect to FIG. 1D, the transfer film 102 may be removed from the assembly such that the printed ink 104 and the pigmented polymer film 120 remain adhered to the substrate 110. As shown, this forms a layered product (or printed product) that includes the pigmented polymer film 120 directly overlying the substrate 110 in the shape/design of the printed ink 104, and the inkjet ink (i.e., printed ink 104) layered on top of the pigmented polymer film 120. In some embodiments, there is no exposed pigmented polymer film 120 (i.e., the pigmented polymer film 120 is entirely covered with the printed ink 104). In some embodiments, the printed ink 104 overlies only the pigmented polymer film 120, and not any portion of the substrate 110.

FIG. 2 shows a method 200 for printing inkjet ink (e.g., ink including dye sublimation pigment, pigment dispersion, and/or dye) onto a substrate using pigmented polymer powders, according to some embodiments. Details of the ink including dye sublimation pigments, pigment dispersions, and/or dyes, are provided above. At step 202, an image is printed onto a transfer film with inkjet ink. In some embodiments, the inkjet printer is equipped with piezo and/or thermal printheads. Step 202 may correspond to FIG. 1A, described above.

Any printer than can print inkjet ink can be used with the printing methods described herein. Suitable inkjet printers can include, but are not limited to, Epson SureColor F170, Epson SureColor F570, Epson SureColor F6470/H, Epson Surecolor F7200, Epson SureColor F10070/H, Epson SureColor F9470/H, Roland Texart RT-640/M, Roland Texart XT-640, Mutoh ValueJet 2638WX, Mutoh ValueJet 1948WX, Mutoh ValueJet 1938WX, Mutoh XpertJet 1682WR, Mutoh XpertJet 1642 WR Pro, Mutoh R-900x, Hewlett Packard Stitch S300, Hewlett Packard Stitch S500, Canon DGI Poseidon Dye Sublimation Printer, Canon DGI FH-3204, Canon DGI FT-3204X, Mimaki TS55-1800, Mimaki TS100-1600, Mimaki TS300P-1800, Mimaki TS330-1600, Mimaki TS500-1800, Mimaki TS500-3200, Mimaki Tiger-1800B MkIII, Mimaki CJV150, Miamki CJV300Plus, Miamki TX300P-1800B, and Mimaki TX500P-3200DS.

At step 204, a pigmented polymer powder is applied to the image printed onto the transfer film. Step 204 may correspond with FIG. 1B, described above. Details of the pigmented polymer powder are described in further detail above.

In some embodiments, the amount of pigmented polymer powder that is applied to and adheres to the printed inkjet ink image is from 0.005 to 1 or from 0.043 to 0.056 g powder/in² ink. In some embodiments, the amount of pigmented polymer power applied to the printed image is less than or equal to 1, 0.75, 0.5, 0.025, 0.1, 0.05, or 0.01 g powder/in² ink. In some embodiments, the amount of pigmented polymer powder applied is greater than or equal to 0.005, 0.01, 0.05, 0.1, 0.25, 0.5, or 0.75 g powder/in² ink.

At step 206, a heat source may be applied to the pigmented polymer powder to melt the pigmented polymer powder, forming a pigmented polymer film overlying the printed image on the transfer film. In some embodiments, step 206 may correspond to FIG. 1B, described in detail above. For example, melting the pigmented polymer powder may include placing the pigmented polymer powder-coated printed film (i.e., image printed on the transfer film and pigmented polymer powder applied to the printed ink/image) into an oven. In some embodiments, melting the pigmented polymer powder may include applying a heat press to the printed and powdered face of the transfer film. In some embodiments, melting the pigmented polymer powder can include placing or hovering the powdered and printed transfer film underneath or on top of a heat source until the pigmented polymer powder adequately melts. The heat source can include a conductive heater, a convective heater, a radiative heater (e.g., an infrared radiative heater), and/or a combination thereof. Any heating process can be used, so long as the heat does not degrade the polymer backing of the film. This application of heat can also remove some of the volatile components of the inkjet ink. In some embodiments, the heat source is applied at 250-350 degrees Fahrenheit for 30 to 120 seconds. For example, a polymer powder with a melting point at 255 degrees F. can be melted using a heat press at 350 for 30 s to 1 minute. In another example, a conveyor with a heater can melt a polymer powder at 290 degrees F. for 2 minutes. In some examples, the heat source is applied at 200-280 degrees F. for 10-20 seconds. In some examples, the heat source is applied at 200-280 degrees F. for 2 minutes. In some embodiments, the heat source is applied at 100-500, 100-400, 150-350, 200-300, or 230-280 degrees Fahrenheit. In some embodiments, the heat source is applied at less than or equal to 500, 400, 380, 350, 320, 300, 290, 280, 270, 260, 250, 240, 230, 220, or 210 degrees Fahrenheit. In some embodiments, the heat source is applied at greater than or equal to 200, 210, 220, 230, 240, 250, 260, 270, 280, 290, 300, 320, 350, 380, 400, or 450 degrees Fahrenheit. In some embodiments, the heat source is applied for 1-180, 1-120, 1-90, 1-60, 5-30, 5-25, or 10-20 seconds. In some embodiments, the heat source is applied for less than or equal to 180, 120, 90, 60, 55, 50, 45, 40, 35, 30, 25, 20, 15, 10, or 5 seconds. In some embodiments, the heat source is applied for greater than or equal to 1, 5, 10, 15, 20, 25, 30, 35, 40, 45, 50, 55, 60, 65, 70, 75, 80, 85, 90, 95, or 120 seconds.

At step 208, the inkjet ink printed image (with pigmented polymer film) can be transferred from the transfer film to the substrate. In some embodiments, step 208 may correspond to FIG. 1D, described in detail above. Step 204 can occur by inverting the printed transfer film such that the printed side of the transfer film is applied face-down (i.e., the face side being the printed side of the transfer film) on the substrate to form a transferring assembly. The transferring assembly includes a pigmented polymer film layer overlying a substrate layer, an inkjet ink (e.g., including dye sublimation pigment, pigment dispersion, and/or dye) layer overlying the pigmented polymer film layer, and a transfer film layer overlying the inkjet ink layer. In some embodiments, the pigmented polymer film layer does not cover the entire surface of the substrate. Instead, the pigmented polymer film layer corresponds to the printed image design of the inkjet ink layer. In some embodiments, the inkjet ink layer does cover the entire pigmented polymer layer. In most cases, there will be void space formed by the pigmented polymer powder film and inkjet ink layers such that there are areas in the transferring assembly that do not include any pigmented polymer powder nor any inkjet ink between the substrate and the transfer film.

Once the transferring assembly is formed, it may be treated with a heat press to cause the transfer of adhesion of the pigmented polymer film layer and the inkjet ink layer from the transfer film to the substrate. In some embodiments, the heat press is applied to the assembly at 392 degrees Fahrenheit for 5 seconds. In some embodiments, the heat press is applied to the assembly at 300 degrees Fahrenheit for 6 or 8 seconds. In some embodiments, the heat press is applied at 100-500, 250-450, 275-325, 300-400, 350-400, 375-425, or 390-395 degrees Fahrenheit. In some embodiments, the heat press is applied at less than or equal to 500, 475, 450, 445, 440, 435, 430, 425, 420, 415, 410, 405, 400, 395, 390, 385, 380, 375, 370, 365, 360, 355, 350, 345, 340, 335, 330, 325, 320, 315, 310, or 305 degrees Fahrenheit. In some embodiments, the heat press is applied at greater than or equal to 100, 125, 150, 175, 200, 225, 250, 260, 270, 275, 280, 285, 290, 295, 300, 325, 350, 355, 360, 365, 370, 375, 380, 385, 390, 395, 400, 405, 410, 415, 420, 425, 430, 435, 440, or 445 degrees Fahrenheit. In some embodiments, the heat press is applied for 1-60, 1-30, 1-15, or 1-10 seconds. In some embodiments, the heat press is applied for less than or equal to 60, 55, 50, 45, 40, 35, 30, 25, 20, 15, 10, or 5 seconds. In some embodiments, the heat press is applied for greater than or equal to 1, 5, 10, 15, 20, 25, 30, 35, 40, 45, 50, 55, 60, 65, 70, 75, 80, 85, 90, or 95 seconds.

In some embodiments, the heat press is applied to the transferring assembly sandwiched between two sheets of parchment paper. The parchment paper can help retain moisture within the transferring assembly. The parchment paper helps to retain some of the moisture that was used to transfer the lower printed ink areas. Specifically, the parchment paper may act by holding the humectant and water of the inkjet ink within the substrate longer, allowing for more adequate transfer of the image. After the heat press has been applied to the transferring assembly and the printed image (i.e., inkjet ink and pigmented polymer powder) have adequate adhesion to the substrate (and no longer to the transfer film), the transfer film can be removed from the assembly to produce the printed product (i.e., pigmented polymer powder and inkjet ink printed image on the substrate).

In some embodiments, an optional post press may be applied to the printed product to further set the printed/transferred image. In some embodiments, the post press may be applied to the printed substrate at 392 degrees Fahrenheit for 5 seconds. In some embodiments, the post press may be applied to the printed substrate at 300 degrees Fahrenheit for 6 or 8 seconds. In some embodiments, the post press is applied at 100-500, 250-450, 300-400, 350-400, 375-425, or 390-395 degrees Fahrenheit. In some embodiments, the post press is applied at less than or equal to 500, 475, 450, 445, 440, 435, 430, 425, 420, 415, 410, 405, 400, 395, 390, 385, 380, 375, 370, 365, 360, 355, 350, 345, 340, 335, 330, 325, 320, 315, 310, or 305 degrees Fahrenheit. In some embodiments, the post press is applied at greater than or equal to 100, 125, 150, 175, 200, 225, 250, 260, 270, 275, 280, 285, 290, 295, 300, 325, 350, 355, 360, 365, 370, 375, 380, 385, 390, 395, 400, 405, 410, 415, 420, 425, 430, 435, 440, or 445 degrees Fahrenheit. In some embodiments, the post press is applied for 1-60, 1-30, 1-20, 1-10, or 5-15 seconds. In some embodiments, the post press is applied for less than or equal to 60, 55, 50, 45, 40, 35, 30, 25, 20, 15, 10, or 5 seconds. In some embodiments, the post press is applied for greater than or equal to 1, 5, 10, 15, 20, 25, 30, 35, 40, 45, 50, 55, 60, 65, 70, 75, 80, 85, 90, or 95 seconds.

### Printed Products Prepared Using the Direct to Film Methods and Processes Described

Also provided herein are printed products prepared using the printing methods and processes described herein. The printed products provided include an inkjet ink (e.g., ink including dye sublimation pigment, pigment dispersion, and/or dye)-printed image or design transferred onto a substrate. In some examples, the substrate includes cotton, cellulose, polyamide, polyvinylchloride, polyacrylate, polyurethane, and/or polyvinylacetate. In some embodiments, the substrate may comprise a textile. For example, the substrate may comprise a natural textile (e.g., cotton, wool, silk). In some embodiments, the substrate may comprise a synthetic textile (e.g., rayon, polyester, acrylic, elastane/spandex). In some embodiments, the substrate may be a combination of natural and synthetic textile. In some embodiments, the substrate may comprise a hard polymer-coated surface, such as a polyester-polymer coated ceramic, metal, wood, or plastic surface. In some embodiments the substrate may be uncoated such as ceramic, metal, wood, or plastic surface. The substrate may be a light-colored (e.g., white, pastel colored) substrate or a dark-colored (e.g., black, standard colored) substrate. The printed product may comprise a pigmented polymer layer overlying a substrate, and a printed ink layer overlying the pigmented polymer layer.

The thickness of the printed ink layer may be 1-100 microns. In some embodiments, the thickness of the printed ink layer may vary between a few microns and about 75 microns. In some embodiments, a maximum thickness of the printed ink layer may be less than or equal to 100, 90, 80, 70, 60, 50, 40, 30, 20, or 10 microns. In some embodiments, a maximum thickness of the printed ink layer may be greater than 1, 10, 20, 30, 40, 50, 60, 70, 80, or 90 microns. In some embodiments, a minimum thickness of the printed ink layer may be less than or equal to 100, 90, 80, 70, 60, 50, 40, 30, 20, or 10 microns. In some embodiments, a minimum thickness of the printed ink layer may be greater than or equal to 1, 10, 20, 30, 40, 50, 60, 70, 80, or 90 microns.

The image or design that has been transferred onto the substrate was achieved using the methods and processes described herein. Specifically, the image can be printed onto a transfer film using inkjet ink (e.g., ink including dye sublimation pigment, pigment dispersion, and/or dye) and an inkjet printer. The inkjet ink may be clear. A pigmented polymer powder can be applied to the printed image on the transfer film and melted to form a pigmented polymer film overlying the printed image. The pigmented polymer powder can be colored, such as white. The pigmented polymer film can then be applied to the substrate such that the inkjet ink printed image and pigmented polymer film on the printed image is between the transfer film and the substrate. With the application of heat, the inkjet ink image and pigmented polymer film can be transferred from the transfer film to the substrate. In some embodiments, the substrate does not need to be pretreated prior to the direct to film printing process/method.

### Additional Definitions

Although the preceding description uses terms first, second, etc. to describe various elements, these elements should not be limited by the terms. These terms are only used to distinguish one element from another.

Also, it is also to be understood that the singular forms “a,” “an,” and “the” used in the preceding description are intended to include the plural forms as well unless the context indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

The term “if” may be construed to mean “when” or “upon” or “in response to determining” or “in response to detecting,” depending on the context.

### Embodiments

The following embodiments are exemplary and are not intended to limit the scope of any invention described herein.

Embodiment 1. A method for direct to film printing dye sublimation ink, comprising:
inkjet printing a design on a transfer film using dye sublimation ink;
applying a pigmented polymer powder to the printed design on the transfer film;
melting the pigmented polymer powder to form a pigmented polymer film overlying the printed design to form a pigmented printed design; and
transferring the pigmented printed design from the transfer film to a substrate.

Embodiment 2. The method of embodiment 1, wherein inkjet printing the design on the transfer film using the dye sublimation ink comprises inkjet printing using an inkjet printer comprising piezo or thermal printheads.

Embodiment 3. A method for direct to film printing inkjet ink, comprising:
inkjet printing a design on a transfer film using inkjet ink;
applying a pigmented polymer powder to the printed design on the transfer film;
melting the pigmented polymer powder to form a pigmented polymer film overlying the printed design to form a pigmented printed design; and
transferring the pigmented printed design from the transfer film to a substrate.

Embodiment 4. The method of embodiment 3, wherein the inkjet ink comprises a dye sublimation pigment, a pigment dispersion, and/or a dye.

Embodiment 5. The method of embodiment 3 or 4, wherein inkjet printing the design on the transfer film using the inkjet ink comprises inkjet printing using an inkjet printer comprising piezo or thermal printheads.

Embodiment 6. The method of any one of embodiments 1-5, wherein melting the pigmented polymer powder comprises applying a heat source to the pigmented printed design at 200-280° F. for 10-20 seconds.

Embodiment 7. The method of any one of embodiments 1-5, wherein melting the pigmented polymer powder comprises applying a heat source to the pigmented printed design at 250-350° F. for 30-120 seconds.

Embodiment 8. The method of embodiment 6 or 7, wherein the heat source comprises a conductive heater, convective heater, and/or a radiative heater.

Embodiment 9. The method of any one of embodiments 1-8, wherein transferring the pigmented printed design from the transfer film to the substrate comprises applying a heat press to the transfer film comprising the pigmented printed design that is pressed face down on the substrate.

Embodiment 10. The method of embodiment 9, wherein the heat press is applied at 390-395° F. for 1-10 seconds.

Embodiment 11. The method of embodiment 9, wherein the heat press is applied at 300-400° F. for 1-10 seconds.

Embodiment 12. The method of any one of embodiments 1-11, comprising removing the transfer film from the pigmented printed design to form a printed substrate.

Embodiment 13. The method of embodiment 12, comprising post pressing the printed substrate at 390-395° F. for 10-20 seconds.

Embodiment 14. The method of embodiment 12, comprising post pressing the printed substrate at 300-400° F. for 1-10 seconds.

Embodiment 15. The method of any one of embodiments 1-14, wherein applying the pigmented polymer powder to the printed design on the transfer film to form the pigmented printed design comprises applying 0.03-0.05 g powder/in² ink to the printed design.

Embodiment 16. The method of any one of embodiments 1-15, wherein the substrate comprises one or more of cotton, cellulose, polyamide, polyvinylchloride, polyacrylate, or polyvinylacetate.

Embodiment 17. The method of any one of embodiments 1-15, wherein the substrate comprises one or more of cotton, cellulose, polyamide, polyvinylchloride, polyacrylate, polyurethane, and polyvinylacetate.

Embodiment 18. The method of any one of embodiments 1-17, wherein the substrate is dark in color.

Embodiment 19. The method of any one of embodiments 1-18, wherein the pigmented polymer powder is light in color.

Embodiment 20. The method of embodiment 19, wherein the pigmented polymer powder is white.

Embodiment 21. The method of any one of embodiments 1-20, wherein the pigmented polymer powder comprises a pigment and a polymer.

Embodiment 22. The method of any one of embodiments 1-21, wherein the pigmented polymer powder comprises between 5-25 wt. % pigment.

Embodiment 23. The method of embodiment 22, wherein the polymer comprises one or more of polyester or polyurethane.

Embodiment 24. The method of embodiment 22 or 23, wherein the pigment comprises one or more of titanium dioxide, zinc sulfide, zinc oxide, lithopones, lead carbonate, antimony (III) oxide, calcium carbonate, barium sulfate, or talc.

Embodiment 25. The method of any one of embodiments 1-24, wherein the transfer film is a cold peel film.

Embodiment 26. The method of any one of embodiments 1-25, wherein the transfer film is a hot peel film.

Embodiment 27. A printed product prepared from a method for direct to film printing dye sublimation ink comprising the steps of:
inkjet printing a design on a transfer film using dye sublimation ink;
applying a pigmented polymer powder to the printed design on the transfer film;
melting the pigmented polymer powder to form a pigmented printed design; and
transferring the pigmented printed design from the transfer film to a substrate to form a printed product.

Embodiment 28. The printed product of embodiment 27, wherein inkjet printing a design on the transfer film using the dye sublimation ink comprises inkjet printing using an inkjet printer comprising piezo or thermal printheads.

Embodiment 29. A printed product prepared from a method for direct to film printing inkjet ink comprising the steps of:
inkjet printing a design on a transfer film using inkjet ink;
applying a pigmented polymer powder to the printed design on the transfer film;
melting the pigmented polymer powder to form a pigmented printed design; and
transferring the pigmented printed design from the transfer film to a substrate to form a printed product.

Embodiment 30. The printed product of embodiment 29, wherein inkjet printing a design on the transfer film using the inkjet ink comprises inkjet printing using an inkjet printer comprising piezo or thermal printheads.

Embodiment 31. The printed product of embodiment 29 or 30, wherein the inkjet ink comprises a dye sublimation pigment, a pigment dispersion, and/or a dye.

Embodiment 32. The printed product of any one of embodiments 27-31, wherein melting the pigmented polymer powder comprises applying a heat source to the pigmented printed design at 200-280° F. for 10-20 seconds.

Embodiment 33. The printed product of any one of embodiments 27-31, wherein melting the pigmented polymer powder comprises applying a heat source to the pigmented printed design at 250-350° F. for 30-120 seconds.

Embodiment 34. The printed product of embodiment 32 or 33, wherein the heat source comprises a conductive heater, convective heater, and/or a radiative heater.

Embodiment 35. The printed product of any one of embodiments 27-34, wherein transferring the pigmented printed design from the transfer film to the substrate comprises applying a heat press to the transfer film comprising the pigmented printed design that is pressed face down on the substrate.

Embodiment 36. The printed product of embodiment 35, wherein the heat press is applied at 390-395° F. for 1-10 seconds.

Embodiment 37. The printed product of embodiment 35, wherein the heat press is applied at 300-400° F. for 1-10 seconds.

Embodiment 38. The printed product of any one of embodiments 27-37, wherein the method comprises removing the transfer film from the printed design.

Embodiment 39. The printed product of embodiment 37, wherein the method comprises post pressing the printed product at 390-395° F. for 10-20 seconds.

Embodiment 40. The printed product of embodiment 38, wherein the method comprises post pressing the printed product at 300-400° F. for 1-10 seconds.

Embodiment 41. The printed product of any one of embodiments 27-40, wherein applying the pigmented polymer powder to the printed design on the transfer film to form the pigmented printed design comprises applying 0.03-0.05 g powder/in² ink to the printed design.

Embodiment 42. The printed product of any one of embodiments 27-41, wherein the substrate comprises one or more of cotton, cellulose, polyamide, polyvinylchloride, polyacrylate, or polyvinylacetate.

Embodiment 43. The printed product of any one of embodiments 27-41, wherein the substrate comprises one or more of cotton, cellulose, polyamide, polyvinylchloride, polyacrylate, polyurethane, and polyvinylacetate.

Embodiment 44. The printed product of any one of embodiments 27-43, wherein the substrate is dark in color.

Embodiment 45. The printed product of any one of embodiments 27-44, wherein the pigmented polymer powder is light in color.

Embodiment 46. The printed product of embodiment 45, wherein the pigmented polymer powder is white.

Embodiment 47. The printed product of any one of embodiments 27-46, wherein the pigmented polymer powder comprises a pigment and a polymer.

Embodiment 48. The printed product of any one of embodiments 27-47, wherein the pigmented polymer powder comprises between 5-25 wt. % pigment.

Embodiment 49. The printed product of embodiment 47 or 48, wherein the polymer comprises one or more of polyester or polyurethane.

Embodiment 50. The printed product of any one of embodiments 46-49, wherein the pigment comprises one or more of titanium dioxide, zinc sulfide, zinc oxide, lithopones, lead carbonate, antimony (III) oxide, calcium carbonate, barium sulfate, or talc.

Embodiment 51. The printed product of any one of embodiments 27-50, wherein the transfer film is a cold peel film.

Embodiment 52. The printed product of any one of embodiments 27-50, wherein the transfer film is a hot peel film.

### EXAMPLES

### Direct to Film Printing Processes

Exemplary direct to film printing processes for various types of ink and for printing on various types of material are provided herein. The examples are not intended to be limiting to the scope of the disclosure provided herein.

Dye sublimation ink (i.e., inkjet ink including a dye sublimation pigment) is printed on polyester and cotton using direct to film printing processes. For printing dye sublimation ink on either a polyester or cotton substrate, only white fabrics can be printed on unless a pigmented polymer powder is used. When a pigmented polymer powder is used, dark fabrics can be printed on. To print dye sublimation ink on either a polyester substrate or a cotton substrate, the polymer powder is melted at 250 degrees Fahrenheit for 2 minutes. The printed design is then heat pressed at 392 degrees Fahrenheit for 6 seconds.

Dye sublimation ink that includes a pigment dispersion (i.e., inkjet ink including a dye sublimation pigment and pigment dispersion) is printed on polyester and cotton using direct to film printing processes. Dye sublimation ink including a pigment dispersion can be printed on either light or dark fabrics but requires a pigmented polymer powder for printing direct to film on dark fabric. To print dye sublimation ink including a pigment dispersion on either a polyester substrate or a cotton substrate, the polymer powder is melted at 250 degrees Fahrenheit for 2 minutes. The printed design is then heat pressed at 300 degrees Fahrenheit for 8 seconds.

Pigment dispersion ink (i.e., inkjet ink including a pigment dispersion) is printed on polyester and cotton using direct to film printing processes. Pigment dispersion ink can be printed on either light or dark fabrics but requires a pigmented polymer powder for printing direct to film on dark fabric. To print pigment dispersion ink on either a polyester substrate or a cotton substrate, the polymer powder is melted at 250 degrees Fahrenheit for 2 minutes. The printed design is then heat pressed at 300 degrees Fahrenheit for 8 seconds.

Pigment dispersion ink with dye (i.e., inkjet ink including a pigment dispersion and dye) is printed on polyester and cotton using direct to film printing processes. Pigment dispersion ink with dye can be printed on either light or dark fabrics but requires a pigmented polymer powder for printing direct to film on dark fabric. To print pigment dispersion ink with a dye on either a polyester substrate or a cotton substrate, the polymer powder is melted at 250 degrees Fahrenheit for 2 minutes. The printed design is then heat pressed at 300 degrees Fahrenheit for 8 seconds.

### Using White Pigmented Polymer Powder to Improve Color Transfer and Brightness

Testing was performed to analyze the effect of adding white pigment to a polymer powder used in direct to film printing processes, as described herein.

Methods: The methods for printing the ink using various compositions of pigmented polymer powder were as follows. First, using a Titan Mini 4720 printer with Epson i3200 printheads, an image was printed using a pigment ink (i.e., inkjet ink including a pigment dispersion) for each of cyan, magenta, yellow, black, and white ink on a hot peel transfer film, Ecofreen®'s Ultimate film.

Next, the printed transfer film was powdered with a polymer powder, i.e., a white pigmented polymer powder or a clear powder (for the control). The pigment was titanium dioxide (otherwise known as white) which was blended with polyurethane pellets. The amounts of white pigment tested were 4 wt. %, 8 wt. %, and 12 wt. % white pigment added to clear powder. The remainder of the polymer powder (i.e., 96 wt. %, 92 wt. %, and 88 wt. %, respectively) was polyurethane pellets. Clear powder with white ink (as is conventionally used) was also tested for comparison.

Following powdering the printed image, the transfer film (with the image and the powder) was heated using a T700 oven (convective and radiative heat source), with a conveyer, at 250 degrees F. for 120 seconds (2 minutes). Heating the powder created a pigmented polymer film over the printed ink image. The image was then transferred from the film to a black cotton t-shirt (Fruit of the Loom HD 100% Cotton t-shirt), using an Insta heat press at 300 degrees Fahrenheit for 6 seconds with medium pressure. While heating, parchment paper sandwiched the film—substrate assembly. The image was then post-pressed at 300 degrees Fahrenheit for another 6 seconds using the Insta heat press with medium pressure. Again, while heating, parchment paper sandwiched the film—substrate assembly. The color and density were measured using a SpectroDens spectrophotometer (Techkon).

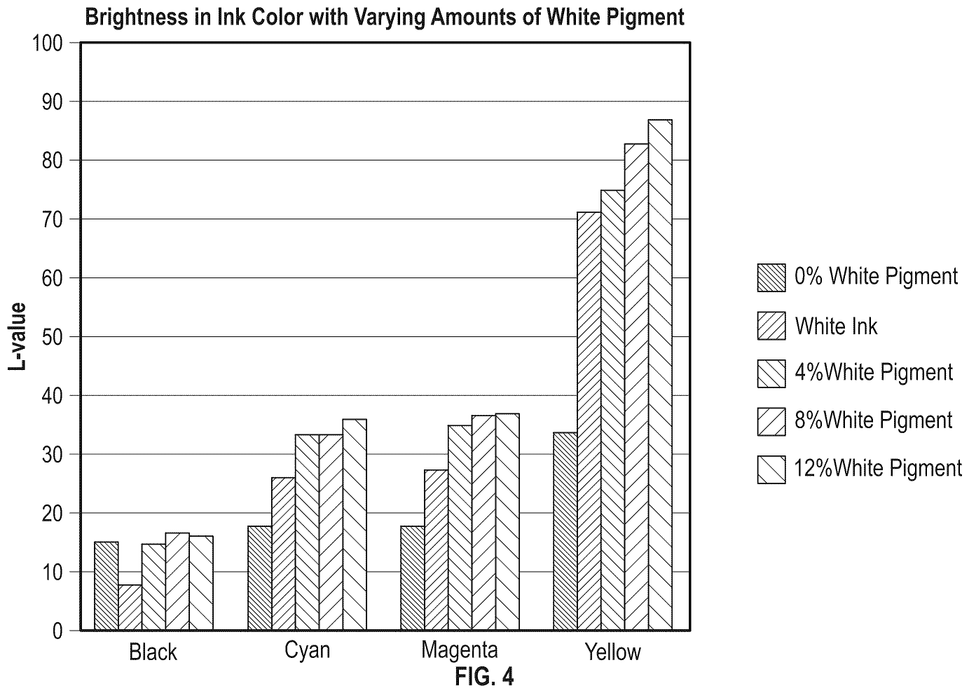

Results: The results of printing with various amounts of white pigment are shown in FIG. 4 and Table 1 below. The L, a* and b* values are x, y, and z coordinates for color space. The L values corresponds to the lightness and darkness of the color. The L value is from 0-100, with 0 being dark/black and 100 being light/white. The a* corresponds to the red/green value, with positive values corresponding to how red the color is, and negative values to how green it is. The b* value corresponds to the yellow/blue values of the color, with positive values corresponding to how yellow a color is, and negative values corresponding to how blue the color is.

| | | | | | |
|---|---|---|---|---|---|
| | Clear | | Clear | Clear | Clear |
| | Powder | Clear | Powder + | Powder + | Powder + |
| Ink | (0% White | Powder + | 4% White | 8% White | 12% White |
| Color | Pigment) | White Ink | Pigment | Pigment | Pigment |

Black

| | | | | | |
|---|---|---|---|---|---|
| Density | 1.72 | 2.088 | 1.736 | 1.662 | 1.686 |
| L | 15.074 | 7.726 | 14.732 | 16.5 | 15.916 |
| a* | 0.292 | −0.082 | 0.338 | 0.242 | 0.262 |
| b* | −1.958 | −3.28 | −2.024 | −2.1 | −2.004 |

Cyan

| | | | | | |
|---|---|---|---|---|---|
| Density | 1.616 | 2.172 | 1.628 | 1.614 | 1.566 |
| L | 17.812 | 25.998 | 33.286 | 33.198 | 35.846 |
| a* | 3.494 | 5.982 | 3.18 | 3.986 | 4.138 |
| b* | −8.588 | −50.75 | −49.794 | −49.754 | −53.06 |

Magenta

| | | | | | |
|---|---|---|---|---|---|
| Density | 1.586 | 1.938 | 1.624 | 1.572 | 1.6 |
| L | 17.702 | 27.364 | 34.812 | 36.4 | 36.854 |
| a* | 9.454 | 56.114 | 60.37 | 61.93 | 64.25 |
| b* | −5.802 | −3.634 | 2.894 | 3.734 | 4.114 |

Yellow

| | | | | | |
|---|---|---|---|---|---|
| Density | 1.128 | 1.744 | 1.476 | 1.414 | 1.438 |
| L | 33.862 | 71.166 | 74.716 | 82.548 | 86.556 |
| a* | −20.312 | −14.948 | −11.214 | −9.444 | −8.798 |
| b* | 17.172 | 83.482 | 80.786 | 90.586 | 97.616 |

FIG. 4 is a plot of the L-value provided in Table 1 for each of the ink colors. As shown, the addition of white pigment to the polymer improves the color transfer and ink brightness, with the amount of improvement generally increasing as the amount of white pigment in the polymer powder is increased.

For black ink, the L-value was highest with 8% of white pigment in the polymer powder. Both 8% and 12% of white pigment exhibited an improvement over using clear powder. Each of 4%, 8%, and 12% exhibited an improvement over using white ink. For each of cyan, magenta, and yellow ink, the L-value was highest with 12% of white pigment in the polymer powder. Each of 4%, 8%, and 12% exhibited an improvement in ink brightness over using clear powder and using white ink.

### Conclusion

The preceding description sets forth exemplary methods, parameters, and the like. It should be recognized, however, that such description is not intended as a limitation on the scope of the present disclosure but is instead provided as a description of exemplary embodiments. The illustrative embodiments described above are not meant to be exhaustive or to limit the disclosure to the precise forms disclosed. Many modifications and variations are possible in view of the above teachings. The embodiments were chosen and described to best explain the principles of the disclosed techniques and their practical applications. Others skilled in the art are thereby enabled to best utilize the techniques, and various embodiments with various modifications as are suited to the particular use contemplated.

Although the disclosure and examples have been thoroughly described with reference to the accompanying figures, it is to be noted that various changes and modifications will become apparent to those skilled in the art. Such changes and modifications are to be understood as being included within the scope of the disclosure and examples as defined by the claims. In the preceding description of the disclosure and embodiments, reference is made to the accompanying drawings, in which are shown, by way of illustration, specific embodiments that can be practiced. It is to be understood that other embodiments and examples can be practiced, and changes can be made without departing from the scope of the present disclosure.

1. A method for direct to film printing inkjet ink, comprising:
inkjet printing a design on a transfer film using inkjet ink;
applying a pigmented polymer powder to the printed design on the transfer film;
melting the pigmented polymer powder to form a pigmented polymer film overlying the printed design to form a pigmented printed design; and
transferring the pigmented printed design from the transfer film to a substrate.

2. The method of claim 1, wherein the inkjet ink comprises a dye sublimation pigment, a pigment dispersion, and/or a dye.

3. The method of claim 1, wherein inkjet printing the design on the transfer film using the inkjet ink comprises inkjet printing using an inkjet printer comprising piezo or thermal printheads.

4. The method of claim 1, wherein melting the pigmented polymer powder comprises applying a heat source to the pigmented printed design at 250-350° F. for 30-120 seconds.

5. The method of claim 4, wherein the heat source comprises a conductive heater, convective heater, and/or a radiative heater.

6. The method of claim 1, wherein transferring the pigmented printed design from the transfer film to the substrate comprises applying a heat press to the transfer film comprising the pigmented printed design that is pressed face down on the substrate.

7. The method of claim 6, wherein the heat press is applied at 300-400° F. for 1-10 seconds.

8. The method of claim 1, comprising removing the transfer film from the pigmented printed design to form a printed substrate.

9. The method of claim 8, comprising post pressing the printed substrate at 300-400° F. for 1-10 seconds.

10. The method of claim 1, wherein applying the pigmented polymer powder to the printed design on the transfer film to form the pigmented printed design comprises applying 0.03-0.05 g powder/in² ink to the printed design.

11. The method of claim 1, wherein the substrate comprises one or more of cotton, cellulose, polyamide, polyvinylchloride, polyacrylate, polyurethane, and polyvinylacetate.

12. The method of claim 1, wherein the substrate is dark in color.

13. The method of claim 1, wherein the pigmented polymer powder comprises between 5-25 wt. % pigment.

14. The method of claim 13, wherein the pigmented polymer powder is white.

15. The method of claim 1, wherein a polymer of the pigmented polymer powder comprises one or more of polyester or polyurethane.

16. The method of claim 1, wherein a pigment of the pigmented polymer powder comprises one or more of titanium dioxide, zinc sulfide, zinc oxide, lithopones, lead carbonate, antimony (III) oxide, calcium carbonate, barium sulfate, or talc.

17. The method of claim 1, wherein the transfer film is a cold peel film.

18. The method of claim 1, wherein the transfer film is a hot peel film.

19. A printed product prepared from a method for direct to film printing inkjet ink comprising the steps of:
inkjet printing a design on a transfer film using inkjet ink;
applying a pigmented polymer powder to the printed design on the transfer film;
melting the pigmented polymer powder to form a pigmented printed design; and
transferring the pigmented printed design from the transfer film to a substrate to form a printed product.

20. The printed product of claim 9, wherein the inkjet ink comprises a dye sublimation pigment, a pigment dispersion, and/or a dye.
